(19) United States
(12) Patent Application Publication
(10) Pub. No.: US 2024/0128610 A1
(43) Pub. Date: Apr. 18, 2024

(54) ELECTROCHEMICAL CELL, ELECTROCHEMICAL SYSTEM, AND METHOD FOR PRODUCING AN ELECTROCHEMICAL CELL

(71) Applicant: ElringKlinger AG, Dettingen (DE)

(72) Inventors: Mathias WIDMAIER, Neuhausen auf den Filden (DE); Mathias SCHERER, Sigmaringen (DE); Christian BECK, Jettingen-Scheppach (DE); Elisabeth REITZ, Tübingen (DE); Marcel KURZ, Metzingen (DE); Philipp ROMINGER, Metzingen (DE); Aldina ASLANI, Reutlingen (DE)

(73) Assignee: ElringKlinger AG, Dettingen (DE)

(21) Appl. No.: 18/391,806

(22) Filed: Dec. 21, 2023

Related U.S. Application Data
(63) Continuation of application No. PCT/EP2022/067436, filed on Jun. 24, 2022.

(30) Foreign Application Priority Data
Jul. 5, 2021 (DE) 10 2021 207 011.6

(51) Int. Cl. H01M 50/559; H01M 10/04; H01M 50/107; H01M 50/152; H01M 50/188; H01M 50/342; H01M 50/548; H01M 50/566; H01M 50/578; H01M 50/581

(52) U.S. Cl. CPC H01M 50/559; H01M 10/0431; H01M 10/049; H01M 50/107; H01M 50/152; H01M 50/188; H01M 50/3425; H01M 50/548; H01M 50/566; H01M 50/578; H01M 50/581; H01M 2200/10; H01M 2200/20

(57) ABSTRACT

In order to provide an electrochemical cell (100) that can be produced as simply as possible and has as long a service life as possible, according to the invention an electrochemical cell (100), in particular a cylindrical cell, is provided, which comprises: an electrochemical element (104), a housing (106), a first cell terminal (118) and a second cell terminal (120); wherein the electrochemical cell (100) also comprises a cast element, in particular a first cast element (128), for connecting the housing (106) and the first cell terminal (118) and/or a cast element, in particular a second cast element (154), for connecting the housing (106) and the second cell terminal (120).

### RELATED APPLICATION

This application is a continuation of international application No. PCT/EP2022/067436 filed on Jun. 24, 2022, and claims the benefit of German application No. 10 2021 207 011.6 filed on Jul. 5, 2021, which are incorporated herein by reference in their entirety and for all purposes.

### FIELD OF DISCLOSURE

The present invention relates to an electrochemical cell for an electrochemical system.

The present invention concerns an electrochemical system comprising one or more electrochemical cells.

The present invention also relates to a method for producing an electrochemical cell.

### BACKGROUND

Electrochemical cells are known from DE 10 2018 209 270 A1, DE 10 2017 200 390 A1, EP 2 541 650 A1, US 2015/0214516 A1, DE 10 2012 213 871 A1, EP 1 459 882 A1, US 2018/0097208 A1 and WO 2017/159760 A1.

### SUMMARY OF THE INVENTION

The present invention is based on the object of providing an electrochemical cell that is as simple as possible to manufacture and possesses a very long life.

This object is achieved by an electrochemical cell according to claim 1.

The electrochemical cell is preferably a cylindrical cell.

For example, the electrochemical cell is used in vehicles.

The electrochemical cell preferably comprises an electrochemical element for receiving, storing and/or providing electrical energy.

It can be advantageous if the electrochemical cell comprises a housing that comprises a cup element for accommodating the electrochemical element and a cover element for covering and/or closing the cup element.

The electrochemical cell comprises in particular a first cell terminal and a second cell terminal for connecting the electrochemical cell to a cell contacting system.

It can be beneficial if the electrochemical cell comprises a cast element, in particular a first cast element, for example for connecting the housing and the first cell terminal.

Additionally or alternatively, the electrochemical cell comprises a cast element, in particular a second cast element, for example for connecting the housing and the second cell terminal.

A “cast element” is preferably an element that is produced in a casting method and/or a potting method. In a casting method and/or a potting method, a potting material, for example a resin material, is preferably filled in a flowable state into a region to be filled.

For example, the first cell terminal is designed as a cathode.

The second cell terminal is designed, for example, as an anode.

The first cast element preferably forms a first connecting element. Additionally or alternatively, the first cast element preferably forms a first sealing element for sealing a region formed between the cup element and the first cell terminal.

It can be beneficial if the second cast element forms a second connecting element. Additionally or alternatively, the second cast element preferably forms a second sealing element for sealing a region formed between the cover element and the second cell terminal.

The first cast element and/or the second cast element preferably serve to seal an interior space of the electrochemical cell surrounded by the housing.

It can be advantageous if the cup element comprises a metallic material or is formed therefrom. For example, the cup element comprises aluminum or is formed therefrom. According to a preferred embodiment, the cup element is formed from nickel-plated steel.

According to another preferred embodiment, the cup element comprises aluminum or is formed therefrom.

It can be beneficial if the cup element lies against the potential of the second cell terminal.

According to another preferred embodiment, the cup element lies against the potential of the first cell terminal.

Preferably, the cup element is at least approximately hollow-cylindrical. In particular, one end of the hollow cylinder is closed by a base section and/or bottom section of the cup element.

It can be advantageous if the cup element has a shell section, which is preferably at least approximately hollow cylindrical, for example at least approximately circular hollow cylindrical.

It can be provided that the cup element has a base section which, for example, is at least approximately circular. For example, the base section closes the cup element when the electrochemical cell is in an assembled state at a side of the cup element facing away from the second cell terminal. The base section, for example, is a bottom section.

It can be advantageous if the electrochemical cell comprises a first current collector element, which comprises at least one first connecting element for connecting the first current collector element to the first cell terminal and/or for electrically contacting the electrochemical element and the first cell terminal, wherein the at least one first connecting element is designed in the form of a bulge pointing in the direction of the first cell terminal and/or in the form of a projection pointing in the direction of the first cell terminal.

The at least one first connecting element is preferably connected to the first cell terminal by materially bonding and/or form-fitting and/or force-fitting, for example by welding.

For example, it is conceivable that the at least one first connecting element of the first current collector element is a bowl-shaped and/or cup-shaped region of the current collector element. Preferably, the first current collector element is largely plate-shaped, for example over approximately 90% of the surface or more. For example, the first current collector element is a current collector plate.

It can be advantageous if a preferably fluid-tight welded connection is formed by a side of the first cell terminal facing away from the first current collector element. For example, the first connecting element is fixed to the first cell terminal by welding through from a side facing away from the first cell terminal.

It can be beneficial if the electrochemical cell comprises a second current collector element, which comprises at least one second connecting element for connecting the second current collector element to the second cell terminal and/or for electrically contacting the electrochemical element and the second cell terminal. The at least one second connecting element is preferably designed in the form of a bulge pointing in the direction of the second cell terminal and/or in the form of a projection pointing in the direction of the second cell terminal.

For example, the at least one second connecting element is connected to the second cell terminal by material bonding and/or form-fitting and/or force-fitting, for example by welding.

It can be provided that the second current collector element has a first bend, for example a bend by approximately 180°, in a cross-section taken parallel to the central axis of the electrochemical cell.

Preferably, the second current collector element has a second bend, for example of around 90°.

In embodiments that have a second current collector element, a first, and/or a second bend, it can be advantageous if the second cell terminal is arranged eccentrically.

For example, one end of the second current collector element is guided through an opening provided for this in the second cell terminal and is materially bonded to the second cell terminal within the opening.

It can be provided that the second cell terminal and the at least one second connecting element are formed at least partially from different metallic materials.

For example, the second cell terminal is multipart and comprises a first part, which comprises or is formed from copper.

In particular, the second cell terminal comprises a second part which, for example, comprises or is formed from aluminum.

The at least one second connecting element preferably comprises copper or is formed therefrom.

For example, a material transition is formed within the second cell terminal or between the at least one second connecting element and the second cell terminal.

It can be provided that different regions are formed in the second cell terminal which regions are surrounded by the second cast element and/or are separated from one another.

For example, a connection region is formed in which the second cell terminal is connected to the at least one second connecting element.

The connection region of the second cell terminal is formed, for example, from the same material as the at least one second connecting element of the second current collector element.

Alternatively to a material transition being formed between the second cell terminal and the at least one second connecting element, it can be provided that the second cell terminal and the at least one second connecting element are formed from the same metallic material.

For example, the second cell terminal and the at least one second connecting element comprise copper or are formed therefrom.

Alternatively to the second current collector element having at least one second connecting element designed as a bulge and/or projection, it can be provided that the electrochemical cell has a second current collector element whose plate-shaped main body and/or whose edge region is directly connected to the housing, wherein the second current collector element is preferably connected to the cover element and the cup element, for example by a joint connection.

Preferably, the second current collector element is and/or will be connected by crimping to the cover element and/or the cup element.

In particular for forming an optimized joint connection between the cup element and the cover element, it can be advantageous if the cup element has at least one depression, for example a bead running around in the circumferential direction of the cup element, at an end facing away from the bottom section.

As an alternative to a connection of the second current collector element and the housing by a joint connection, it can be provided that the second current collector element is connected to the second cell terminal by welding, for example by through-welding. According to this embodiment, the second current collector element is preferably arranged at a distance from the cover element.

It can be provided that the second current collector element is connected to the second cell terminal by a second connecting element of the second current collector element. For example, it is conceivable that the second connecting element of the second current collector element is a bowl-shaped and/or cup-shaped region of the second current collector element. Preferably, the second current collector element is largely plate-shaped, for example over approximately 90% of the surface or more. For example, the second current collector element is a current collector plate.

It can be advantageous if a preferably fluid-tight welded connection is formed by a side of the first cell terminal facing away from the first current collector element. For example, the first connecting element is fixed to the first cell terminal by welding through from a side facing away from the first cell terminal.

For example, an insulating element, for example a second insulating element, is arranged on an inner side of the cover element facing the interior space and serves to electrically insulate the cover element.

It can be beneficial if the cover element and the cup element are connected to one another in a bonded and/or force-fitting and/or positive-locking manner. The cover element and the cup element are preferably welded to one another, for example connected to one another by through-welding.

For example, it is conceivable for the first current collector element to be connected to the cup element by means of an in particular a fluid-tight weld seam. According to this embodiment, the cup element is in particular at the potential of the first cell terminal and/or forms a part of the first cell terminal. A first insulating element is preferably unnecessary.

Additionally or alternatively, it is conceivable for the second current collector element to be connected to the cover element by means of an in particular fluid-tight weld seam.

Preferably, the at least one first connecting element and/or the at least one second connecting element form a tolerance compensation.

When the electrochemical cell is in the assembled state, the at least one first connecting element is preferably in direct material contact with the first cell terminal. For example, the at least one first connecting element is bonded to the first cell terminal.

In particular, when the electrochemical cell is in the assembled state, the at least one second connecting element is in direct material contact with the second cell terminal. For example, the at least one second connecting element is materially bonded to the second cell terminal.

It can be provided that the at least one first connecting element is formed by bending and/or cutting out, for example punching out.

Additionally or alternatively, it can be provided that the at least one second connecting element is formed by bending and/or cutting out, for example punching out.

It can be advantageous if the electrochemical cell has a first insulating element that forms an electrical isolation and/or an electrical insulation between the first cell terminal and the cup element.

Additionally or alternatively, it can be beneficial if the electrochemical cell has a second insulating element that forms an electrical isolation and/or an electrical insulation between the second cell terminal and the cover element.

The first insulating element preferably serves to electrically insulate the first cell terminal. In particular, the first insulating element is arranged on an inner side of the base section and/or the bottom section of the cup element.

It can be beneficial for the first insulating element to be made of several parts, for example two parts. For example, the insulating element has an at least approximately circular cross-section. The cross-section is preferably at least approximately perpendicular to a central axis of the electrochemical cell.

The central axis of the electrochemical cell is preferably parallel to an axis of symmetry of the electrochemical cell and/or at least approximately perpendicular to a main extension plane of the cover element and/or the base section of the cup element.

It can be advantageous if the first insulating element has a recess, for example centrally, in which the first cell terminal is accommodated and/or arranged when the electrochemical cell is in an assembled state.

Preferably, the recess of the first insulating element is at least approximately rectangular in a cross-section taken parallel to the main extension plane of the first insulating element.

For example, it is conceivable that the first cell terminal is formed at least approximately complementary to the recess of the first insulating element in a cross-section taken parallel to the main extension plane of the first cell terminal.

For example, the first cell terminal and the recess of the first insulating element are at least approximately rectangular or at least approximately oval and/or round in a cross-section taken perpendicular to the central axis of the electrochemical element.

Preferably, the first cell terminal and/or the recess of the first insulating element are rectangular in cross-section with rounded corners.

It can be advantageous if the first insulating element has one or more depressions, which are formed running around the recess. The one or more depressions are preferably groove-shaped depressions and/or beads.

For example, the first insulating element has a first depression and a second depression, which are arranged concentrically in a cross-section taken parallel to the main extension plane of the first insulating element.

The first depression serves in particular to position the first cell terminal in the recess of the first insulating element during the production of the electrochemical cell.

The second depression preferably serves to position the first insulating element relative to the cover element during the production of the electrochemical cell.

It can be beneficial if the electrochemical cell has a second insulating element.

Preferably, the second insulating element serves to electrically insulate the second cell terminal or an electrical isolation of the first cell terminal and the second cell terminal. In particular, the second insulating element is arranged on an inner side of the cover element facing the inner side of the electrochemical cell.

It can be beneficial for the second insulating element to be formed in several parts, for example in two parts. For example, the second insulating element has an at least approximately circular cross-section. The cross-section is preferably at least approximately perpendicular to a central axis of the electrochemical cell.

It can be advantageous if the second insulating element has a recess, for example centrally, in which, when the electrochemical cell is in an assembled state, the second cell terminal or the first cell terminal and the second cell terminal are accommodated and/or arranged.

Preferably, the recess of the second insulating element is at least approximately rectangular in a plane taken parallel to the main extension plane of the second insulating element.

For example, it is conceivable that the second cell terminal is formed at least approximately complementary to the recess of the second insulating element in a cross-section taken parallel to the main extension plane.

For example, the second cell terminal and the recess of the second insulating element are at least approximately rectangular or at least approximately oval and/or round in a cross-section taken perpendicular to the central axis of the electrochemical cell.

Preferably, the second cell terminal and/or the recess of the second insulating element is rectangular in cross-section with rounded corners.

It can be advantageous if the second insulating element has one or more depressions, which are formed circumferentially around the recess. The one or more depressions are preferably groove-shaped depressions and/or beads.

For example, the second insulating element has a first depression and a second depression, which are arranged concentrically in a cross-section taken parallel to the main extension plane of the second insulating element.

The first depression serves in particular to position the second cell terminal or the first cell terminal and the second cell terminal in the recess of the second insulating element during the production of the electrochemical cell.

The second depression preferably serves to position the second insulating element relative to the cover element during the production of the electrochemical cell.

It can be advantageous if the first cast element comprises or is formed from a first polymer material, and/or for the second cast element to comprise or be formed from a second polymer material.

The first insulation element preferably comprises or is formed from a third polymer material. For example, the second insulating element comprises or is formed from a fourth polymer material.

The third polymer material and/or the fourth polymer material are preferably thermoplastic polymer materials, in particular electrolyte-resistant thermoplastic polymer materials.

Additionally or alternatively, the third polymer material and/or the fourth polymer material are, for example, a polymer materials that can be processed in an injection molding process.

For example, the third polymer material and/or the fourth polymer material comprise one or more of the following materials or are formed therefrom: polyethylene terephthalate, polyethylene, polypropylene, and polybutylene terephthalate.

The third polymer material and/or the fourth polymer material are preferably electrically insulating.

“Electrically conductive” is in particular an electrical conductivity at 25° C. of 10⁻¹ S/m or more, in particular 10⁶ S/m or more.

“Electrically insulating” is in particular an electrical conductivity at 25° C. of less than 10⁻¹ S/m, in particular of less than 10⁶ S/m.

As already mentioned, the first cast element preferably comprises a first polymer material or is formed therefrom. For example, the first polymer material comprises a first resin material or is formed therefrom.

It can be beneficial if the first resin material comprises or is formed from one or more of the following materials: epoxide resin material, phenolic resin material, aminoplastic material, polyurethane material, silicone material, polyester resin material, ABS resin material.

It can be advantageous if the first resin material has a hardness of approx. 40 Shore D or more, in particular of approx. 50 Shore D, for example of approx. 60 Shore D or more, in a cured state to form the first polymer material.

The hardness of the first resin material in a cured state to form the first polymer material is approximately 100 Shore D or less, in particular approximately 97 Shore D or less, for example approximately 95 Shore D or less.

The hardness is determined in particular according to DIN EN ISO 868.

It may be advantageous for the first resin material to have a glass transition temperature of approximately 90° C. or more, in particular of approximately 95° C. or more, for example of approximately 100° C. or more. The glass transition temperature is preferably based on a cured state of the first resin material to form the first polymer material.

Preferably, the first resin material is a one-component resin material, for example a one-component epoxide resin material.

One-component epoxide resin materials preferably have increased stability compared to an electrolyte, which is accommodated in the interior space.

It can be beneficial if the first resin material comprises one or more fillers. The one or more fillers are preferably selected from: inorganic fillers, in particular silicon oxide, carbonate, carbide, in particular silicon carbide, nitride, in particular metal nitride, and metal oxide.

Preferred silicon oxides are silicates.

By using fillers, oxygen diffusion and/or water diffusion from an environment of the electrochemical cell into the interior space via the first cast element can be avoided or reduced.

It can be advantageous if the second cast element comprises or is formed from a second polymer material. For example, the second polymer material comprises a second resin material or is formed therefrom.

It can be beneficial if the second resin material comprises or is formed from one or more of the following materials: epoxide resin material, phenolic resin material, aminoplastic material, polyurethane material, silicone material, polyester resin material, ABS resin material.

It can be advantageous if the second resin material has a hardness of approx. 40 Shore D or more, in particular approx. 50 Shore D, for example approx. 60 Shore D or more, in a cured state to form the second polymer material.

The hardness of the second resin material in a cured state to form the second polymer material is approximately 100 Shore D or less, in particular approximately 97 Shore D or less, for example approximately 95 Shore D or less.

The hardness is determined in particular according to DIN EN ISO 868.

It can be beneficial if the second resin material has a glass transition temperature of approx. 90° C. or more, in particular of approx. 95° C. or more, for example of approx. 100° C. or more. The glass transition temperature is preferably based on a cured state of the second resin material to form the second polymer material.

The second resin material is preferably a one-component resin material, for example a one-component epoxide resin material.

One-component epoxide resin materials preferably have increased stability compared to an electrolyte, which is accommodated in the interior space.

It can be advantageous if the second resin material comprises one or more fillers. The one or more fillers are preferably selected from: inorganic fillers, in particular silicon oxide, carbonate, carbide, in particular silicon carbide, nitride, in particular metal nitride, and metal oxide.

Preferred silicon oxides are silicates.

By using fillers, oxygen diffusion and/or water diffusion from an environment of the electrochemical cell into the interior space via the second cast element can be avoided or reduced.

Preferably, the first polymer material and the second polymer material are chemically and/or physically different materials.

Alternatively, it can be provided that the first polymer material and the second polymer material are chemically and/or physically identical materials.

Additionally or alternatively, it can be provided that the third polymer material differs chemically and/or physically from the first polymer material and/or from the second polymer material. Alternatively, the third polymer material can correspond chemically and/or physically to the first polymer material and/or to the second polymer material.

It can be provided that the first cast element is arranged in radial directions with respect to a central axis of the electrochemical cell between the first cell terminal and the cup element, and/or that the second cast element is arranged between the second cell terminal and the cover element in radial directions with respect to the central axis of the electrochemical cell.

For example, the first cast element forms an annular section between the first cell terminal and the cup element when viewed from a side of the cup element facing the cover element.

Additionally or alternatively, it is conceivable that the second cast element forms an annular section between the first cell terminal and the cup element on an outer side of the cover element facing the interior space.

It can be advantageous if the cover element and/or the cup element comprises a rupture device, which has a rupture web that is designed in such a way that it breaks and/or tears when a critical pressure is exceeded in the interior space of the electrochemical cell. For example, a rupture device can be arranged and/or formed in a base region of the cup element.

Preferably, the rupture web is formed by a linear region of reduced material thickness and/or depressions, for example embossings, introduced into the cover element or into the cup element on both sides of the cover element and/or the cup element.

According to an alternative embodiment, it can be provided that the rupture device has a flat region of reduced material thickness compared to the average material thickness of the cover element and/or the cup element.

It can be advantageous if the cover element and/or the cup element has an electrolyte filling opening for filling electrolytes into the interior space of the electrochemical cell and/or for removing electrolytes from the interior space of the electrochemical cell. For example, an electrolyte filling opening can be arranged and/or formed in a base region of the cup element.

The electrolyte filling opening is preferably closed, for example welded, after filling the interior space of the electrochemical cell.

In particular, the second insulating element has an electrolyte filling opening.

It can be beneficial if the cover element has one or more elevations, which project away from a main body of the cover element in a direction pointing away from the interior space, wherein the one or more elevations preferably border an opening for accommodating the second cast element.

The one or more elevations serve in particular to increase the filling level when filling in the second potting material. For example, the one or more elevations are formed by beads.

It can be beneficial if the second cell terminal has one or more radial projections, which extend along radial directions with respect to the central axis of the electrochemical cell. For example, the second cell terminal has a single projection, which is designed to surround a main body of the second cell terminal. The second cast element can therefore mechanically interlock with the second cell terminal.

For example, the second cell terminal is embossed and/or has one or more radial projections running in the radial direction. The one or more radial projections serve in particular to increase the filling level of a second resin material.

With regard to the design of the cover element, it can be advantageous if the cover element has one or more recesses in which the second cast element engages behind the cover element when the electrochemical cell is in an assembled state along a direction running parallel to the central axis.

It can be provided that the electrochemical cell, for example the second cell terminal, comprises at least one snap-on element which, when a critical pressure and/or a critical temperature is exceeded in the interior space of the electrochemical cell, can be deflected and/or is deflected from an resting state into a triggered state to the outside. For example, an electrical contact between the second cell terminal and a second current collector element is interrupted and/or broken.

By switching the at least one snap-on element from the resting state into the triggered state, in particular an electrically conductive connection between the second cell terminal and the second current collector element, which is connected to the electrochemical element, is broken.

Preferably, the at least one snap-on element is formed by the second cell terminal as a whole.

Alternatively, the at least one snap-on element can, for example, be welded into the second cell terminal of the electrochemical cell.

The at least one snap-on element is deflected to the outside at a predetermined internal cell pressure and thereby interrupts an electrically conductive connection between the second cell terminal and the second current collector element.

The increased internal cell pressure arises in particular from electrochemical processes and by the heat generated from overcharging the electrochemical cell.

It can be advantageous if the first cell terminal and/or the second cell terminal have a region of reduced material thickness which, in particular, serves to facilitate a connection of the particular cell terminal to the particular current collector element. The region or regions of reduced material thickness are preferably low-embossed regions. In the region of reduced material thickness, the particular cell terminal preferably has a reduced welding depth.

Preferably, the second cell terminal has a plurality of functional regions, which are separated from one another by the second cast element, wherein the plurality of functional regions are preferably separated from one another by one or more, in particular circumferential, elevations, for example beads, or wherein the several functional regions themselves are designed as elevations and/or plateaus relative to a main body.

It can be provided that the electrochemical cell comprises a single cast element, by which the second cell terminal, or the first cell terminal and the second cell terminal, are accommodated and/or surrounded.

According to this embodiment, the electrochemical element is connected to the cup element on a side facing the base section of the cup element, in particular exclusively, by a first insulating element.

It can be provided that the cup element as a whole lies on the potential of the first cell terminal. According to this embodiment, the first current collector element is preferably pressed into and/or pressed by the cup element.

According to an alternative embodiment, it can be provided that the electrochemical element is electrically insulated from the cup element by a first insulating element.

According to this embodiment, the first cell terminal and the second cell terminal are arranged, for example, on the same side of the electrochemical cell and/or anchored in the same cast element. Preferably, the first current collector element and the second current collector element are arranged on the same side of the electrochemical cell and/or on the same side as the cell terminals.

According to this embodiment, both the first cell terminal and the second cell terminal are preferably arranged in the same opening of the cover element.

For example, the first cell terminal and the second cell terminal are separated from one another by the cast element and/or held at a distance from the cover element.

It can be advantageous if the electrochemical cell comprises a second insulating element, which comprises a first recess for the first cell terminal and a first recess for the second cell terminal.

In particular, the first recess and/or the second recess are surrounded by one or more depressions, for example one or more beads. The depressions serve for positioning in the cover element.

It can be beneficial if the electrochemical cell has one or more spacer elements. The one or more of the spacer elements is arranged, for example, between the cover element and the first cell terminal. Additionally or alternatively, for example, the one or more of the spacer elements is arranged between the cover element and the second cell terminal.

For example, it is conceivable that the first current collector element of the electrochemical cell is connected to the cup element by a first spring element, for example by a spring washer.

For example, the first connecting element is formed by the first spring element. Preferably, the first spring element comprises aluminum or is formed therefrom.

Additionally or alternatively, it is conceivable that the second current collector element is connected to the cover element and/or the second cell terminal by a second spring element, for example a spring washer.

For example, the second connecting element is formed by the second spring element. The second spring element comprises, for example, copper or is formed therefrom.

By means of the first spring element and/or by the second spring element, for example a force-fitting connection of the particular current collector element to the corresponding cell terminal is formed.

It can be provided that the first current collector element has an electrically conductive and/or electrolyte-resistant coating.

Additionally or alternatively, it can be provided that the second current collector element has an electrically conductive and/or electrolyte-resistant coating.

In embodiments in which the first current collector element has an electrically conductive and/or electrolyte-resistant coating, and/or in which the first current collector element has an electrically conductive and/or electrolyte-resistant coating, a non-positive connection is preferably formed by pressing the first current collector element into the cup element.

Preferably, the electrically conductive and/or electrolyte-resistant coating comprises or is formed from an electrically conductive fluoropolymer material or a synthetic rubber material.

For example, the following compositions are suitable as material for the electrically conductive and/or electrolyte-resistant coating:
a1) a resin material and one or more electrically conductive additives, for example an epoxide resin material and one or more conductive carbon blacks;
a2) an elastomer material and a transition metal carbide, and optionally one or more electrically conductive additives, for example ethylene-propylene-diene rubber or styrene-butadiene rubber and titanium carbide;
a3) an electrically conductive adhesive material, preferably an elastomer material, a resin material, one or more electrically conductive additives, and optionally a transition metal oxide, for example ethylene-propylene-diene rubber or styrene-butadiene rubber, an epoxide resin material, conductive carbon black, and optionally titanium carbide;
a4) an electrically conductive thermoplastic material, in particular a thermoplastic material, one or more electrically conductive additives, and a transition metal oxide, for example polyvinylidene fluoride or polytetrafluoroethylene and conductive carbon black and titanium carbide;
a5) an electrically conductive paste, for example comprising styrene-butadiene rubber, carboxymethyl cellulose, titanium carbide, wherein optionally a fluoropolymer suspension can be used.

It can be beneficial if the electrochemical element is at least approximately hollow-cylindrical and/or has a cavity parallel to the central axis of the electrochemical cell.

The present invention further relates to an electrochemical system that has one or more electrochemical cells according to the invention.

One or more features and/or advantages of the electrochemical cell according to the invention preferably apply equally to the electrochemical system according to the invention.

The invention also relates to a method for producing an electrochemical cell.

In this respect, the invention is based on the task of providing a method by means of which an electrochemical cell can be produced as simply as possible.

According to the invention, this object is achieved by an electrochemical cell according to the independent method claim.

The method according to the invention is preferably a method for producing an electrochemical cell according to the invention.

An electrochemical element for receiving, storing and/or providing electrical energy is preferably provided or produced.

The electrochemical element is in particular positioned in a housing, which comprises a cup element for accommodating the electrochemical element and a cover element for covering and/or closing the cup element.

A cast element, in particular a first cast element, is preferably produced, for example for connecting the cup element to a first cell terminal.

Additionally or alternatively, a cast element, in particular a second cast element, is produced, for example for connecting the cover element to a second cell terminal.

One or more features and/or one or more advantages of the electrochemical cell according to the invention preferably apply equally to the method according to the invention.

It can be provided that a first insulating element is positioned on a for example rod-shaped tool carrier. Subsequently, for example, the first cell terminal is positioned in a recess provided for this purpose in the insulating element.

It can be beneficial if the cup element is then positioned in such a way that the first insulating element is positioned and/or rests against an inner side of the cup element facing an interior.

Preferably, after positioning the first insulating element relative to the cup element, a first polymer material is filled in a flowable state into a region between the first cell terminal and the cup element. The first polymer material is then preferably cured and/or dried.

It can be provided that an electrochemical element is produced, for example wound, in such a way that one or more first contacting projections and/or one or more second contacting projections, which extend away from a main body of the electrochemical element, are formed. The one or more first contacting projections and/or second contacting projections project, for example, beyond the main body of the electrochemical element and/or protrude from the main body.

For example, the electrochemical element comprises one or more first contacting projections for electrically contacting the electrochemical element with the first cell terminal. For example, the one or more first contacting projections project away from the main body of the electrochemical element on a side of the electrochemical element facing the first cell terminal in an assembled state. The one or more first contacting projections are, for example, lamellar and/or tab-shaped.

Additionally or alternatively, it can be provided that the electrochemical element comprises one or more second contacting projections for electrically contacting the electrochemical element with the second cell terminal. For example, the one or more second contacting projections project away from the main body of the electrochemical element at a side of the electrochemical element facing away from the first cell terminal in a mounted state. The one or more second contacting projections are, for example, lamellar and/or tab-shaped.

The one or more first contacting projections and/or the one or more second contacting projections are, for example, uncoated.

It can be advantageous if the one or more first contacting projections are connected, for example welded, to a first current collector element.

Preferably, the one or more second contacting projections are connected, for example welded, to the second current collector element.

For example, it is conceivable that the one or more first contacting projections are and/or will be formed from an uncoated cathode substrate, for example aluminum.

Additionally or alternatively, it is conceivable that the one or more second contacting projections are and/or will be formed from uncoated anode substrate, for example copper.

It can be provided that the electrochemical element is inserted into the cup element and that subsequently, a first current collector element of the electrochemical cell is connected, for example welded, to the first cell terminal.

It can be advantageous if, after positioning of the electrochemical element in the cup element, the cover element is arranged on a second current collector element, and the cup element is connected to the cover element and the second current collector element by joining, for example by crimping.

It can be beneficial if a second insulating element, the cover element, and the second cell terminal are stacked before they are cast together with a first resin material and/or a second resin material in a flowable state.

For example, the first polymer material and/or the second polymer material is then dried and/or cured, wherein the cast element is formed.

For example, it is conceivable that the electrochemical element is produced by being wound on and/or around a winding device, for example a winding mandrel, whereby in particular a cavity is formed parallel to the central axis of the electrochemical cell.

The winding device is preferably removed from the electrochemical element, in particular the cell winding, after the winding and/or before further assembly.

It can be advantageous if a cover element assembly is formed, which comprises or is formed in particular from the following elements:
the cover element;
the second cell terminal;
the second cast element; and
the second insulating element.

For example, the cover element assembly is connected to the electrochemical element, which is connected to the first current collector element and/or to the second current collector element.

Preferably, the cover element assembly is welded to the second current collector element, for example by laser welding and/or resistance welding. In embodiments in which the cover element assembly and the second current collector element are connected to one another by resistance welding, a long rod-shaped electrode is preferably used.

In particular, the cavity formed by the winding of the electrochemical element is welded through. For this purpose, it can be advantageous if the first current collector element has an opening through which a laser beam can be guided.

For example, the cup element has a passage opening in its base section through which is welded. The passage opening is then in particular sealed, for example welded.

After welding the cover element assembly and the second current collector element, a resulting cell winding cover element assembly is preferably inserted into the cup element and its position is adjusted. Electrolyte is then preferably filled into the interior space of the resulting electrochemical cell through the electrolyte filling opening, and the electrolyte filling opening is then sealed fluid-tight, for example by welding.

For example, it is conceivable for the cup element to have an electrolyte filling opening in a base section facing away from the cover element. For example, the electrolyte is filled through the opening in the first current collector element.

Alternatively, the electrolyte filling opening is preferably arranged in the cover element, and the interior space is filled with electrolyte from there.

In one embodiment of the invention, it can be provided that the second cell terminal is arranged substantially radially in the middle, and that a (first) bend of the second current collector element is designed to be loop-like, and/or rounded, and/or continuously curved.

A second insulating element preferably accommodates the entire second current collector element. For this purpose, the second insulating element is designed, for example, to be at least approximately cup-shaped and/or disk-shaped.

The cover element assembly is preferably easily to attach or plug onto a cup element, wherein the second insulating element is preferably inserted together with the second current collector element into an open end of the cup element, in particular until the open end of the cup element comes to rest against a cover element of the cover element assembly, in particular on a cover plate, and can be connected thereto, for example clamped, welded, etc.

A side of the second current collector element facing the electrochemical element preferably comprises a plurality of, for example five, elevations, which are elevated in the direction of the electrochemical element. The elevations are in particular beads. The elevations extend in particular in a star shape in the radial direction toward the outside. The elevations preferably form welding regions for solid welding on the electrochemical element.

Furthermore, it can be provided that a side of the first current collector element facing the electrochemical element preferably comprises a plurality of, for example three, elevations, which are increased in the direction of the electrochemical element. The elevations are in particular beads. The elevations extend in particular in a star shape in the radial direction toward the outside. The elevations preferably form welding regions for solid welding on the electrochemical element.

Furthermore, the first current collector element preferably comprises one or more openings, for example slots or elongated holes. The one or more openings extend in particular in the radial direction and/or are arranged and/or formed uniformly distributed in the circumferential direction. In particular, elevations and openings are arranged and/or formed alternatingly.

In particular, an optimized behavior of the electrochemical cell for degassing and/or in a thermal event can be achieved by the openings. In particular, a gas forming between the layers of the electrochemical element can be easily removed through the openings.

In the case of optional variants of base sections of the cup element, a filling opening is provided centrally, for example, which is surrounded by a circumferential embossing, for example, to be able to be easily welded tight by means of a metal plate, for example.

Furthermore, one or more rupture devices, in particular rupture webs, are optionally provided and/or formed in the bottom sections.

Finally, fastening regions for fastening a (first) current collector element are preferably provided.

In this case, it can be provided that the (first) current collector element will be or is clamped tight or circumferentially welded to the base section in an edge region. The rupture web is, for example, circumferentially annular.

Alternatively to this, an inwardly projecting elevation can be provided, which in particular is designed circular and serves to be welded to the (first) current collector element. An annular rupture web is preferably arranged and/or formed in the bottom section in a radial direction within the elevation.

Furthermore, alternatively thereto, it can be provided that two rupture devices are provided, which are each arranged and/or formed, for example, substantially semi-circularly around the filling opening. For example, web-like elevations oriented substantially radially outwards are arranged and/or formed between the two rupture devices and protrude into the interior space and/or serve to be welded to the (first) current collector element. The elevations are preferably positioned in such a way that the welding does not impair the function of the rupture devices.

The described variants of base sections or only individual features or combinations of features can optionally be provided in individual, several or all embodiments of the electrochemical cell.

Further preferred features and/or advantages of the invention form the subject-matter of the following description and the drawings illustrating embodiments.

### BRIEF DESCRIPTION OF THE DRAWINGS

FIG. 1 shows a schematic sectional view of a first embodiment of an electrochemical cell in which a first cell terminal is fixed to a housing by means of a first cast element, wherein a second cell terminal is formed by the housing;

FIG. 2 shows a schematic sectional view of the cup element, a first insulating element, the first cell terminal and the first cast element from FIG. 1, wherein the cup element has a circumferential bead in a region that is adjacent to an edge of the cup element;

FIG. 3 shows a schematic plan view of the elements from FIG. 2 along a direction denoted by III in FIG. 2 (seen from above);

FIG. 4 shows a schematic plan view of the elements from FIG. 2 along a direction denoted by IV in FIG. 2 (seen from below);

FIG. 5 shows a schematic plan view of a cover element of the housing along a direction denoted by V in FIG. 1, wherein a rupture web formed by double-sided embossing can be seen;

FIG. 6 shows a schematic plan view of a first current collector element from FIG. 1, which has a bowl-shaped first connecting element for connection to the first cell terminal (seen from above);

FIG. 7 shows a schematic plan view of the first insulating element of the first embodiment along a direction denoted by IV in FIG. 2, wherein the first insulating element has two circumferential beads;

FIG. 8 shows a schematic representation of a method for producing a cup element assembly comprising the cup element, the first insulating element, the first cast element, and the first cell terminal according to the first embodiment of the electrochemical cell;

FIG. 9 shows a schematic representation of an embodiment of a method for producing the electrochemical cell according to the first embodiment;

FIG. 10 shows a schematic sectional view of another embodiment of an electrochemical cell in which the second cell terminal is designed in the form of a second cell terminal and which comprises a second cast element by means of which the second cell terminal is fixed to a second insulating element and/or to the cover element;

FIG. 11 shows an enlarged view of the region denoted by XI in FIG. 10;

FIG. 12 shows an enlarged view of the region denoted by XII in FIG. 10;

FIG. 13 shows a schematic sectional view of the electrochemical cell from FIGS. 10 to 12;

FIG. 14 shows a schematic plan view of the cover element, the second cast element, and the second cell terminal from FIG. 13 along a direction denoted by XIV in FIG. 10 and FIG. 13 (seen from above);

FIG. 15 shows a schematic sectional view of the region denoted by XV in FIG. 13 along a plane denoted by XV in FIG. 14;

FIG. 16 shows a schematic plan view of a cover element assembly of another embodiment of an electrochemical cell in which the cover element has a bead encircling an opening, wherein the bead serves to optimize mechanical stability of the cover element assembly, wherein the cover element assembly comprises a cover element, a second cast element, and a second cell terminal;

FIG. 17 shows a schematic sectional view along a plane denoted by XVII in FIG. 16;

FIG. 18 shows a schematic sectional view of a detail of another embodiment of an electrochemical cell, in which the second cell terminal is designed as a snap-on element which, when a critical pressure and/or a critical temperature is exceeded in the interior space of the electrochemical cell, is deflectable and/or deflected from an resting state into a triggered state to the outside, and therefore interrupts and/or disconnects an electrical contact between the second cell terminal and the second current collector element, wherein the resting state is shown in FIG. 18;

FIG. 19 shows a schematic sectional view of the embodiment of an electrochemical cell shown in FIG. 18 when the snap-on element is in a triggered state in which the second cell terminal and the electrochemical element are electrically separated from one another;

FIG. 20 shows a schematic plan view of the second cell terminal from FIGS. 18 and 19;

FIG. 21 shows a schematic sectional view of a detail of another embodiment of an electrochemical cell in which the second cell terminal has a region of reduced material thickness;

FIG. 22 shows a schematic plan view of a variant of a current collector element, which has a connecting element that is formed by a cut-out contour;

FIG. 23 shows a schematic sectional view of the current collector element from FIG. 22;

FIG. 24 shows a schematic plan view of another variant of a current collector element in which the connecting element is connected to a main body of the current collector element via a U-shaped curved section;

FIG. 25 shows a schematic sectional view of the current collector element from FIG. 24;

FIG. 26 shows a schematic plan view of another variant of a current collector element in which the connecting element is designed in a bowl-shaped and/or cup-shaped manner, wherein the current collector element is in particular free of openings and/or forms a closed surface;

FIG. 27 shows schematic sectional view of the current collector element from FIG. 26;

FIG. 28 shows a schematic sectional view of another embodiment of an electrochemical cell in which the second cell terminal is designed at least in two parts, wherein at least two parts of the second cell terminal are formed from different metallic materials;

FIG. 29 shows an enlarged view of the region denoted by XXIX in FIG. 28;

FIG. 30 shows an enlarged view of the region denoted by XXX in FIG. 28;

FIG. 31 shows a schematic plan view of the cover element from FIG. 28 along a direction denoted by XXXI in FIG. 28 (seen from above);

FIG. 32 shows a schematic plan view of another embodiment of an electrochemical cell in which the second cell terminal has a plurality of elevations designed as plateaus;

FIG. 33 shows a schematic sectional view through a plane denoted by XXXIII in FIG. 32;

FIG. 34 shows a schematic sectional view of another embodiment of an electrochemical cell in which the first current collector element is pressed into the cup element;

FIG. 35 shows an enlarged view of the region denoted by XXXV in FIG. 34;

FIG. 36 shows an enlarged view of the region denoted by XXXVI in FIG. 34;

FIG. 37 shows a schematic sectional view of another embodiment of an electrochemical cell in which the first cell terminal and the second cell terminal are accommodated in a common cast element;

FIG. 38 shows an enlarged view of the region denoted by XXXVIII in FIG. 37;

FIG. 39 shows a schematic plan view of the electrochemical cell of FIGS. 37 and 38 along a direction denoted by XXXIX in FIG. 37;

FIG. 40 shows a schematic plan view of the second insulating element of the embodiment from FIGS. 37 to 39;

FIG. 41 shows a schematic view of an embodiment of a method for producing the cover element assembly of the embodiment of an electrochemical cell shown in FIGS. 10 to 15;

FIG. 42 shows a schematic view of an embodiment of a method for the embodiment of an electrochemical cell shown in FIGS. 10 to 15;

FIG. 43 shows a schematic sectional view of another embodiment of an electrochemical cell in which the second current collector element has a bend of approximately 180° and another bend of approximately 90°;

FIG. 44 shows an enlarged view of the region denoted by XLIV in FIG. 43;

FIG. 45 shows a schematic plan view of the second current collector element from FIGS. 43 and 44 in a state before being bent;

FIG. 46 shows a view of an embodiment of a method for producing the electrochemical cell according to FIGS. 43 to 45;

FIG. 47 shows a schematic sectional view of another embodiment of an electrochemical cell in which the first connecting element and/or the second connecting element are spring washers, as a result of which in particular a non-positive connection is formed;

FIG. 48 shows a schematic sectional view of another embodiment of an electrochemical cell in which contacting by means of an electrically conductive and/or electrolyte-resistant coating is formed on the first current collector element and/or on the second current collector element;

FIG. 49 shows a schematic sectional view of another embodiment of an electrochemical cell in which a cell interior is welded via a cavity formed by a winding device;

FIG. 50 shows an enlarged view of the region denoted by L in FIG. 49;

FIG. 51 shows an enlarged view of the region denoted by LI in FIG. 49;

FIG. 52 shows a schematic view of an embodiment of a method for producing an electrochemical cell according to FIGS. 49 to 51;

FIG. 53 shows a schematic sectional view of another embodiment of an electrochemical cell in which a cell inner side is welded via a cavity formed by a winding device and a passage opening in the cup element;

FIG. 54 shows an enlarged view of the region denoted by LIV in FIG. 53;

FIG. 55 shows an enlarged view of the region denoted by LV in FIG. 53;

FIG. 56 shows a schematic view of an embodiment of a method for producing an electrochemical cell according to FIGS. 53 to 55;

FIG. 57 shows a schematic section through another alternative embodiment of a cover element assembly;

FIG. 58 shows a schematic side view of the cover element assembly from FIG. 57;

FIG. 59 shows a schematic perspective view of the cover element assembly from FIG. 57, with a view of its underside;

FIG. 60 shows a schematic plan view of a current collector element;

FIGS. 61 to 63 show schematic plan views of different embodiments of base sections of cup elements.

The same or functionally equivalent elements are provided with the same reference signs in all figures.

### DETAILED DESCRIPTION OF THE DRAWINGS

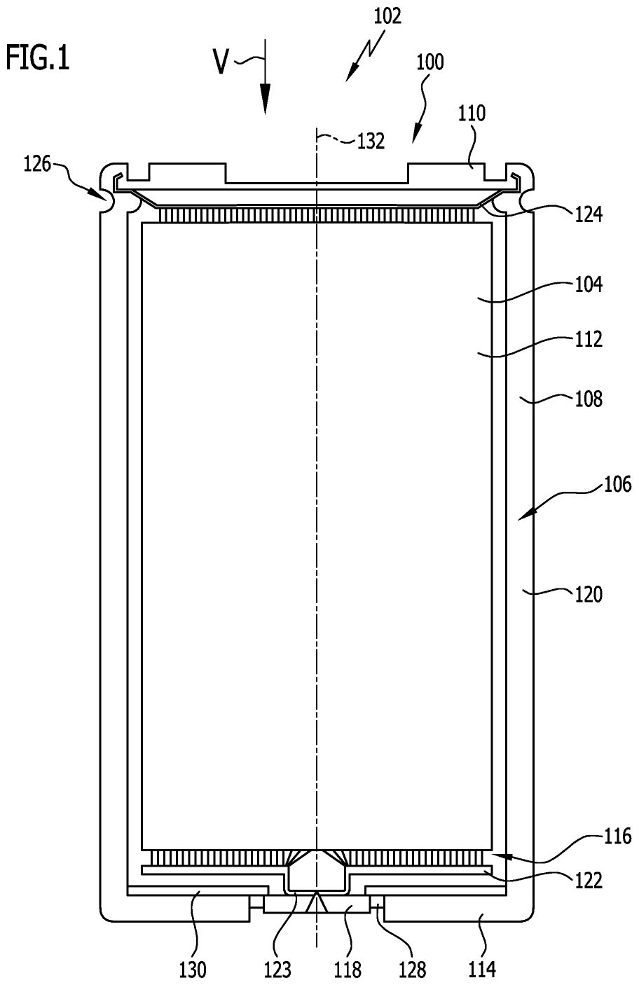

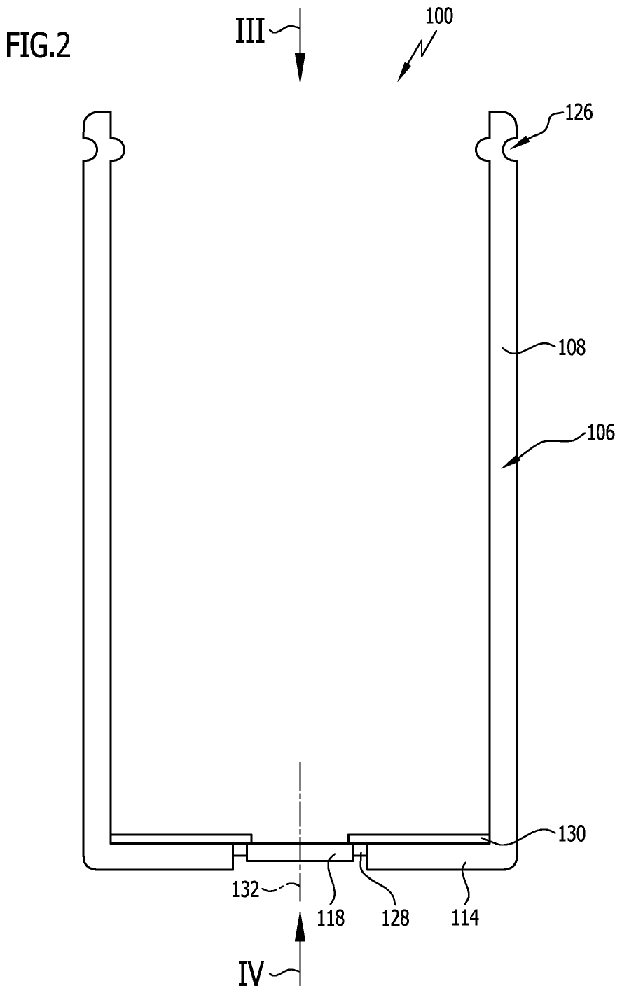

FIGS. 1 to 9 show a first embodiment of an electrochemical cell designated as a whole by 100, the production thereof and individual components of the electrochemical cell 100.

The electrochemical cell 100 is for example a battery cell and/or an accumulator cell. In the present case, the electrochemical cell 100 is a cylindrical cell.

Preferably, the electrochemical cell 100 is a lithium ion cell.

The electrochemical cell 100 preferably forms a component of an electrochemical system 102, which comprises in particular a plurality of electrochemical cells 100.

The electrochemical system 102 is for example an accumulator module and/or a battery module.

For example, the electrochemical cell 100 is used in a vehicle.

The electrochemical cell 100 comprises an electrochemical element 104 for receiving, storing, and/or providing electrical energy. The electrochemical element 104 is, for example, a so-called “cell winding”.

It can be advantageous if the electrochemical element 104 is and/or will be formed by winding around a winding device, for example a winding mandrel.

The electrochemical element 104 is preferably designed to be at least approximately hollow-cylindrical, in particular due to the winding. For example, the electrochemical element 104 has a cavity (not shown in the drawing) parallel to the central axis 132 of the electrochemical cell 100.

Furthermore, the electrochemical cell 100 comprises a housing 106, which comprises a cup element 108 for accommodating the electrochemical element 104 and a cover element 110 for covering and/or closing the cup element 108.

The cup element 108 is preferably designed to be at least approximately cylindrical, wherein it in particular has an at least approximately hollow-cylindrical shell section 112 and a bottom section 114 and/or base section that closes the shell section 112 on one side.

At a side of the cup element 108 facing away from the bottom section 114, the cup element 108 is preferably closed by the cover element 110.

In the present case, the cup element 108 and the cover element 110 are connected to one another in a fluid-tight manner by a joining method, for example crimping. In particular, an interior space 116 of the electrochemical cell 100 is surrounded in a fluid-tight manner by the housing 106.

The electrochemical cell 100 further comprises a first cell terminal 118, for example a first cell terminal, and a second cell terminal 120 for connecting the electrochemical cell 100 to a cell contacting system (not shown in the drawing).

For example, the first cell terminal 118 is designed as a cathode.

The second cell terminal 120 is designed, for example, as an anode. In the present case, the cup element 108 lies against anode potential.

It can be beneficial if the cup element 108 and/or the cover element 110 comprise or are formed from a metallic material. Preferably, the cup element 108 comprises a steel material or is formed therefrom. For example, the cup element 108 comprises nickel-plated steel or is formed therefrom.

The electrochemical cell 100 preferably comprises a first current collector element 122 which, in particular, serves to electrically contact the electrochemical element 104 and the first cell terminal 118. It can be beneficial if the first current collector element 122 comprises a metallic material or is formed therefrom. Aluminum has proven to be particularly suitable as the metallic material for the first current collector element 122.

For example, the first current collector element 122 is and/or will be produced from uncoated aluminum.

It can be beneficial if the first current collector element 122 has at least one, in the present case exactly one, first connecting element 123. The first connecting element 123 serves in particular to connect the first current collector element 122 to the first cell terminal 118 and/or to electrically contact the electrochemical element 104 and the first cell terminal 118.

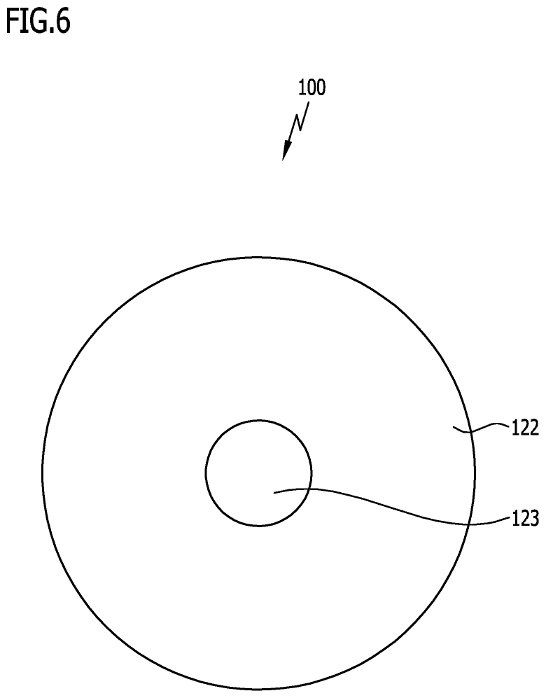

In the present case, the first connecting element 123 is designed in the form of a bulge pointing in the direction of the first cell terminal 118 and/or in the form of a projection pointing in the direction of the first cell terminal 118. For example, the first connecting element 123 is and/or will be embossed into the first current collector element 122. In a cross section taken parallel to a main extension plane of the first current collector element 122, the first connecting element 123 is preferably at least approximately round (see FIG. 6).

For example, it is conceivable that the first connecting element 123 of the first current collector element 122 is a bowl-shaped and/or cup-shaped region of the first current collector element 122. Preferably, the first current collector element 122 is largely plate-shaped, for example over approximately 90% of its surface or more. For example, the first current collector element 122 is a current collector plate.

It can be beneficial if the first connecting element 123 is connected to the first cell terminal 118 in a materially bonded and/or positive and/or non-positive manner.

According to the first embodiment, the first connecting element 123 is connected to the first cell terminal 118 by welding.

It can be advantageous if a preferably fluid-tight welded connection is formed by a side of the first cell terminal 118 facing away from the first current collector element 122.

For example, the first connecting element 123 is fixed to the first cell terminal 118 by through-welding.

In particular, the electrochemical cell 100 comprises a second current collector element 124 which, for example, serves to electrically contact the electrochemical element 104 and the second cell terminal 120.

In the present case, the second current collector element 124 is substantially completely flat and/or plate-shaped. For example, the second current collector element 124 is a current collector plate. In particular, the second current collector element 124 does not have a second connecting element formed by a central bulge.

In the present case, the second current collector element 124 is clamped between the cup element 108 and the cover element 110 and/or connected to them by joining. For example, the second current collector element 124 is fixed by cap-can crimping between edges of the cup element 108 and the cover element 110.

It can be advantageous if, in order to produce the joint connection between the cup element 108 and the cover element 110, a groove-shaped depression 126, for example a circumferential bead, is introduced into the cup element 108 and/or is formed directly adjacent to the cover element 110 and/or is arranged adjacent thereto.

The electrochemical cell 100 further comprises a cast element, for example a first cast element 128, for connecting the cup element 108 and the first cell terminal 118.

The first cast element 128 preferably comprises a first polymer material or is formed therefrom. For example, the first polymer material comprises a first resin material or is formed therefrom.

It can be beneficial if the first resin material comprises or is formed from one or more of the following materials: epoxide resin material, phenolic resin material, aminoplastic material, polyurethane material, silicone material, polyester resin material, ABS resin material.

It can be advantageous if the first resin material has a hardness of approx. 40 Shore D or more, in particular of approx. 50 Shore D, for example of approx. 60 Shore D or more, in a cured state to form the first polymer material.

The hardness of the first resin material in a cured state to form the first polymer material is approximately 100 Shore D or less, in particular approximately 97 Shore D or less, for example approximately 95 Shore D or less.

The hardness is determined in particular according to DIN EN ISO 868.

It may be advantageous for the first resin material to have a glass transition temperature of approximately 90° C. or more, in particular of approximately 95° C. or more, for example of approximately 100° C. or more. The glass transition temperature is preferably based on a cured state of the first resin material to form the first polymer material.

Preferably, the first resin material is a one-component resin material, for example a one-component epoxide resin material.

One-component epoxide resin materials preferably have increased stability compared to an electrolyte, which is accommodated in the interior space 116.

It can be beneficial if the first resin material comprises one or more fillers. The one or more fillers are preferably selected from: inorganic fillers, in particular silicon oxide, carbonate, carbide, in particular silicon carbide, nitride, in particular metal nitride, and metal oxide.

Preferred silicon oxides are silicates.

By using fillers, oxygen diffusion and/or water diffusion from an environment of the electrochemical cell 100 into the interior space 116 via the first cast element 128 can be avoided or reduced.

In the present case, the electrochemical cell 100 comprises a first insulating element 130, which forms an electrical isolation and/or an electrical insulation between the first cell terminal 118 and the cup element 108. The first insulating element 130 is preferably at least approximately plate-shaped.

The first insulating element 130 preferably serves to electrically insulate the first cell terminal 118. For example, the first insulating element 130 is arranged on an inner side of the base section and/or the bottom section 114 of the cup element 108 facing the interior space 116.

It can be provided that the first insulating element 130 is formed in several parts, for example in two parts (not shown).

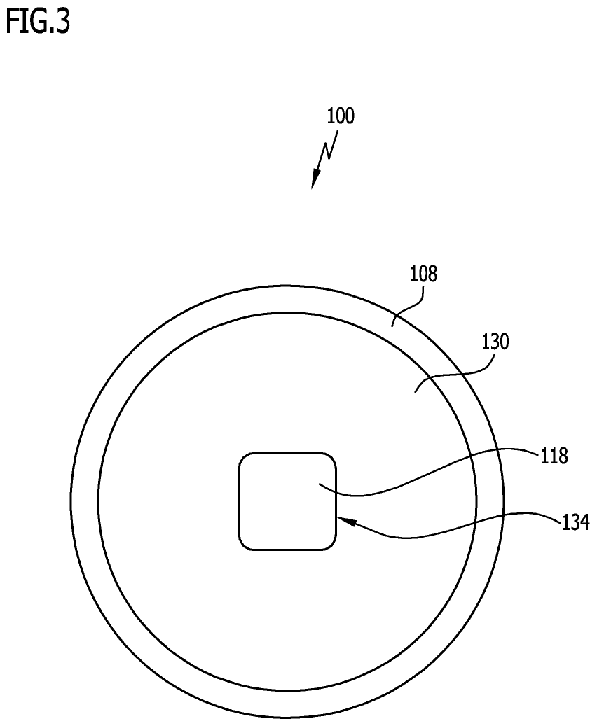

As can be seen in particular in FIG. 3, the first insulating element 130 preferably has an at least approximately circular cross-section as a whole. The cross-section is in particular taken perpendicular to a central axis 132 of the electrochemical cell 100.

The central axis 132 of the electrochemical cell 100 is preferably parallel to an axis of symmetry of the electrochemical cell 100 and/or at least approximately perpendicular to a main extension plane of the cover element 110 and/or the bottom section 114 of the cup element 108.

According to a preferred embodiment, the first insulating element 130 comprises a third polymer material or is formed therefrom.

The third polymer material is preferably a thermoplastic polymer material, in particular an electrolyte-resistant thermoplastic polymer material.

Additionally or alternatively, the third polymer material is, for example, a polymer material that can be processed in an injection molding process.

For example, the third polymer material comprises one or more of the following materials or is formed therefrom: polyethylene terephthalate, polyethylene, polypropylene, and polybutylene terephthalate.

It can be advantageous if the first insulating element 130 has a recess 134, for example centrally, in which the first cell terminal 118 is accommodated and/or arranged when the electrochemical cell 100 is in an assembled state.

Preferably, the recess 134 of the first insulating element 130 is at least approximately rectangular in a cross-section taken parallel to the main extension plane of the first insulating element 130.

For example, it is conceivable that the first cell terminal 118 is formed at least approximately complementary to the recess 134 of the first insulating element 130 in a cross-section taken parallel to its main extension plane.

For example, the first cell terminal 118 and the recess 134 of the first insulating element 130 have, in a cross-section taken perpendicular to the central axis 132 of the electrochemical cell, at least approximately in each case a rectangular shape or at least approximately a circular shape, for example round and/or oval.

As can be seen in particular in FIG. 3, it can be advantageous if the first cell terminal 118 and/or the recess 134 of the first insulating element 130 are at least approximately rectangular with rounded corners in a cross-section taken perpendicular to the central axis 132 of the electrochemical cell 100.

It can be advantageous if the first insulating element 130 has one or more depressions 136, which are arranged circumferentially around the recess 134. The one or more recesses 136 are preferably groove-shaped depressions and/or beads.

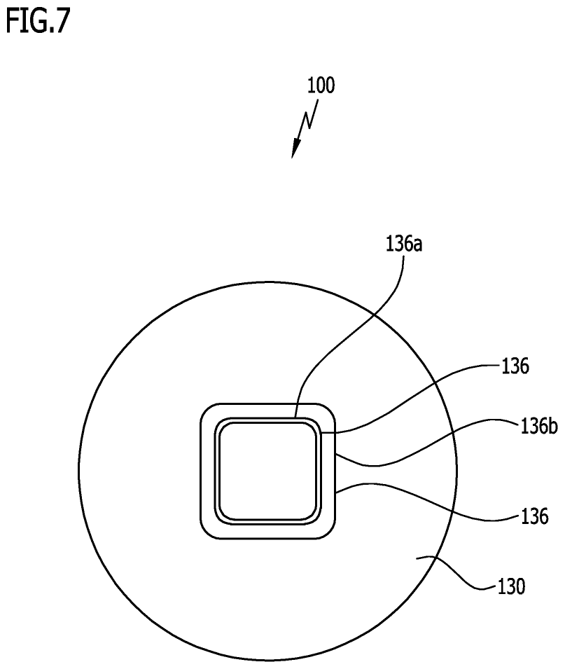

For example, the first insulating element 130 has a first depression 136a and a second depression 136b, which are arranged in one another (see FIG. 7).

The inner first depression 136a serves in particular for positioning the first cell terminal 118 in the recess 134 of the first insulating element 130 during the production of the electrochemical cell 100.

The external second depression 136b preferably serves to position an assembly comprising the first insulating element 130 relative to the cover element 110 during the production of the electrochemical cell 100.

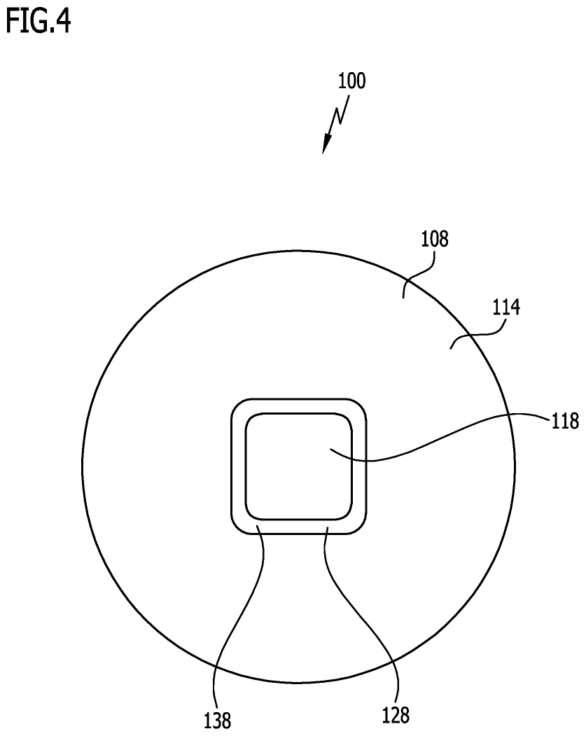

As can be seen in particular in FIG. 4, it can be advantageous if the first cast element 128 is arranged between the first cell terminal 118 and the cup element 108 in radial directions with respect to the central axis 132 of the electrochemical cell 100. For example, the cast element substantially completely fills a cavity between the first insulating element 130, the cup element 108 and the first cell terminal 118.

For example, the first cast element 128 forms an annular section 138 between the first cell terminal 118 and the cup element 108 when viewed from a side of the cup element 108 facing away from the cover element 110.

For example, the first cast element 128 is at least approximately rectangular in a cross-section taken perpendicular to the central axis 132 of the electrochemical cell 100, for example with rounded corners.

Alternatively, it can be provided that the first cast element 128 is at least approximately circular in a cross-section taken perpendicular to the central axis 132 of the electrochemical cell 100. A circular design of the first cast element is preferred in embodiments in which the first cell terminal 118 and/or the recess 134 of the first insulating element 130 are at least approximately circular.

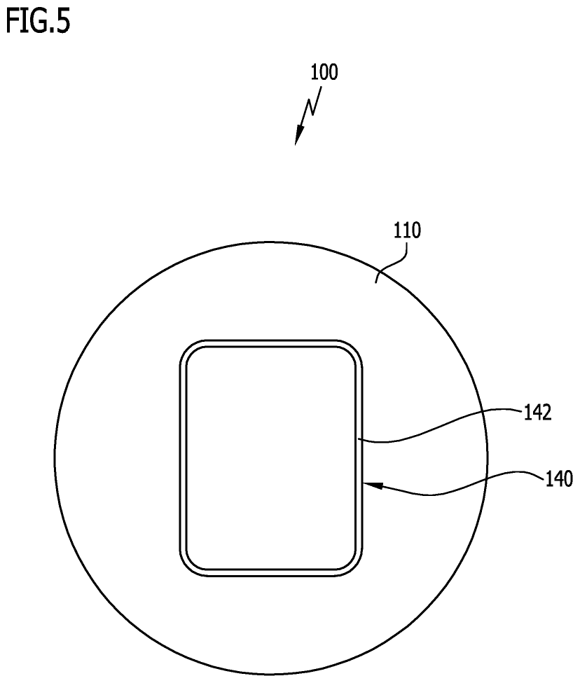

As can be seen in FIG. 5, for example, the cover element 108 preferably comprises a rupture device 140. The rupture device preferably serves to regulate the pressure in the interior space 116 of the electrochemical cell 100.

For example, it is conceivable that the rupture device 140 has a rupture web 142, which is designed in such a way that it breaks and/or tears when a critical pressure is exceeded in the interior space 116 of the electrochemical cell 100. By breaking and/or tearing the rupture web 142, fluid can flow out of the interior space 116 into the environment of the electrochemical cell 100.

It can be advantageous if the rupture web 142 is formed by a linear region of reduced material thickness and/or by two depressions, for example embossings, introduced into the cover element 110 on both sides of the cover element 110.

An average material thickness of the rupture web 142 is preferably approximately 20% or more, in particular approximately 30% or more, for example approximately 40% or more, less than an average material thickness of the cover element 110 in the remaining regions.

The average material thickness of the rupture web 142 is preferably approximately 90% or less, in particular approximately 80% or less, for example approximately 70% or less, than the average material thickness of the cover element 110 in the remaining regions.

The material thickness is preferably defined perpendicular to the main extension plane of the cover element 110.

As an alternative to linear regions of less material thickness, it can be provided that the rupture device 140 comprises or is formed from a flat region of reduced material thickness in comparison to an average material thickness of the cover element 110 in regions adjacent thereto (not shown in the drawing).

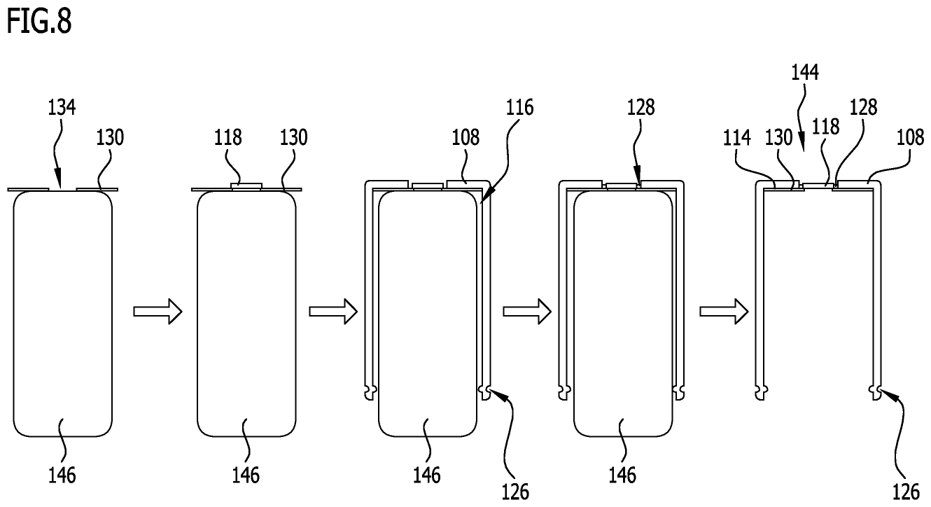

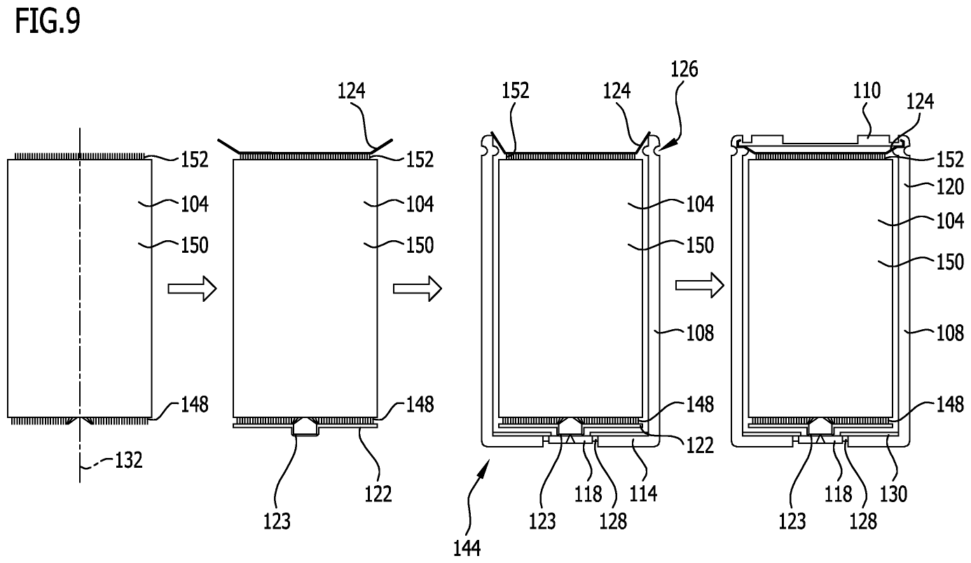

One embodiment of a method for producing the electrochemical cell 100 according to the first embodiment is shown schematically in FIGS. 8 and 9. In particular, the method steps are indicated schematically by the arrows.

A cup element assembly 144 is preferably produced first. The cup element assembly 144 comprises the cup element 108, the first insulating element 130, the first cast element 128, and the first cell terminal 118.

It can be advantageous if the first insulating element 130 is provided and is positioned on a for example rod-shaped tool carrier 146.

Subsequently, for example, the first cell terminal 118 is positioned in a recess 134 provided for this purpose in the first insulating element 130.

It can be beneficial if the cup element 108 is then positioned in such a way that the first insulating element 130 is positioned and/or rests against an inner side of the cup element 108 facing the interior space 116.

For example, the cup element 108, the first insulating element 130, and the first cell terminal 118 are stacked on the tool carrier 146.

Preferably, the first resin material is then filled, for example cast, into a region between the first cell terminal 118 and the cup element 108 in a flowable state. The first resin material is then preferably cured and/or dried. During the curing and/or drying of the first resin material, the first cast element 128 is formed.

With regard to the composition of the first resin material, reference is made to the statements in connection with the first cast element 128.

After the curing and/or drying of the first resin material, the tool carrier 146 is removed. The cup element assembly 144 has formed.

An electrochemical element 104 is preferably provided and/or produced for final assembly and/or mounting of the electrochemical cell 100.

For example, the electrochemical element 104 comprises one or more first contacting projections 148 for electrically contacting the electrochemical element 104 with the first current collector element 122. In the present case, the electrochemical element 104 comprises a plurality of first contacting projections 148.

For example, the first contacting projections 148 project away from a main body 150 of the electrochemical element 104 on a side of the electrochemical element 104 facing the first cell terminal 118 in the assembled state. The first contacting projections 148 are, for example, lamellar and/or tab-like.

It can be provided that the first contacting projections 148 are arranged in such a way that no first contacting projections 148 are located in the first connecting element 125 of the first current collector element 122 when the electrochemical cell 100 is in the assembled state. For example, in a [sic] first contacting projections arranged around the central axis 132 of the electrochemical element 104 are designed to face radially outwards. The central axis of the electrochemical element 104 preferably corresponds to the central axis 132 of the electrochemical cell 100 in the assembled state.

It can be beneficial if the electrochemical element 104 comprises one or more second contacting projections 152 for electrically contacting the electrochemical element 104 with the second current collector element 124. In the present case, the electrochemical element 104 comprises a plurality of second contacting projections 152.

For example, the second contacting projections 152 project away from the main body 150 of the electrochemical element 104 on a side of the electrochemical element 104 facing away from a first cell terminal 118 in the assembled state. The second contacting projections 152 are designed, for example, in lamellar and/or tab-like form.

The one or more first contacting projections 148 and/or the one or more second contacting projections 152 are, for example, uncoated.

It can be advantageous if the first contacting projections 148 are connected, for example welded, to the first current collector element 122.

Preferably, the second contacting projections 152 are connected, for example welded, to the second current collector element 124.

For example, it is conceivable that edge regions of the second current collector element 124 are curved in a direction pointing away from the electrochemical element 104.

It can be beneficial if the electrochemical element 104 is inserted into the cup element 108 after the electrochemical element 104 has been provided and/or produced. For example, the electrochemical element 104 is inserted into the cup element 108 of a cup element assembly 144 produced as described above.

Subsequently, the first current collector element 122 of the electrochemical cell 100 is preferably connected, for example welded, to the first cell terminal 118. For example, the first cell terminal 118 and the first current collector element 122 are connected to one another in the first connecting element 125 of the first current collector element 122 by through-welding. The through-welding is schematically indicated by a triangle in the figures.

In general, material bonds, for example welded connections, are shown in all the figures by a triangle.

It can be advantageous if, after positioning of the electrochemical element 104 in the cup element 108, the cover element 110 is arranged on the second current collector element 124 and the cup element 108 is connected to the cover element 110 and the second current collector element 124 by joining, for example by crimping.

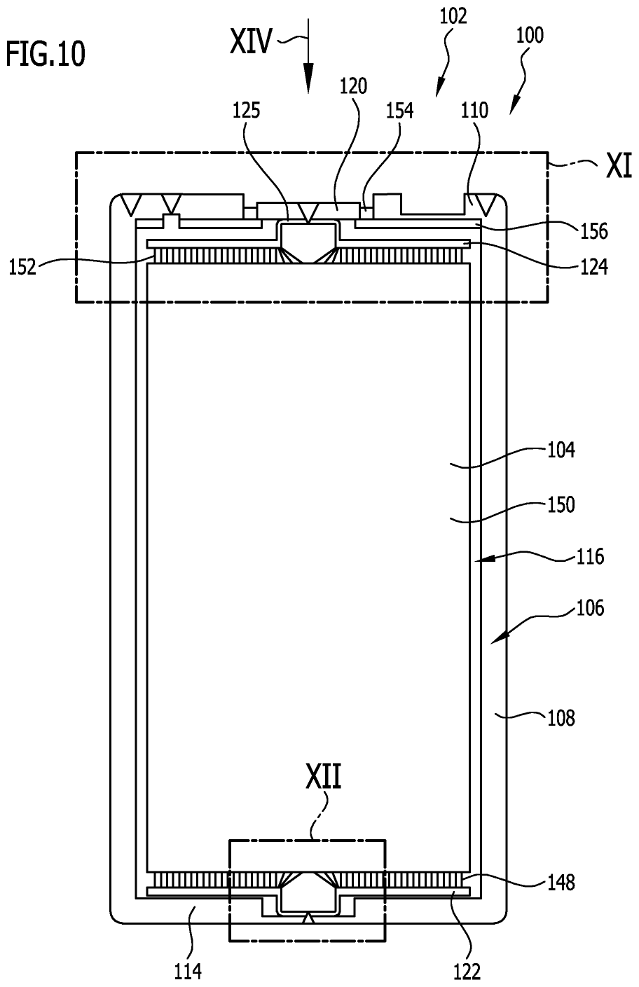

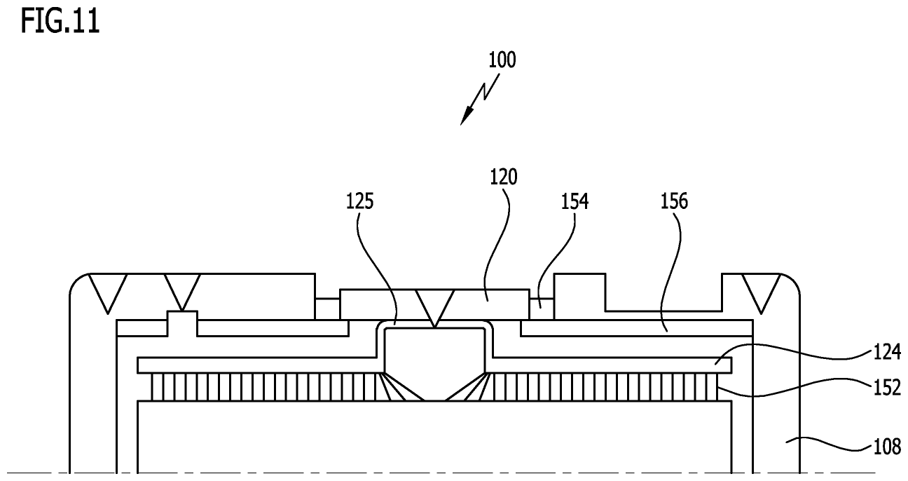

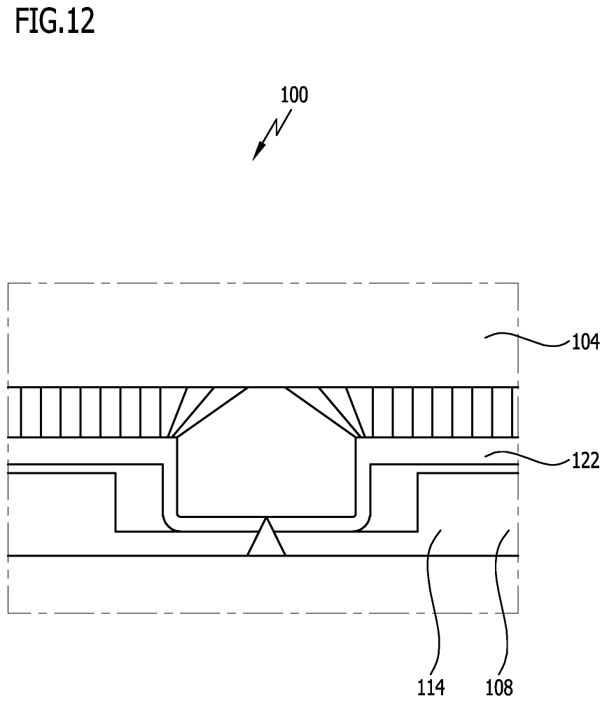

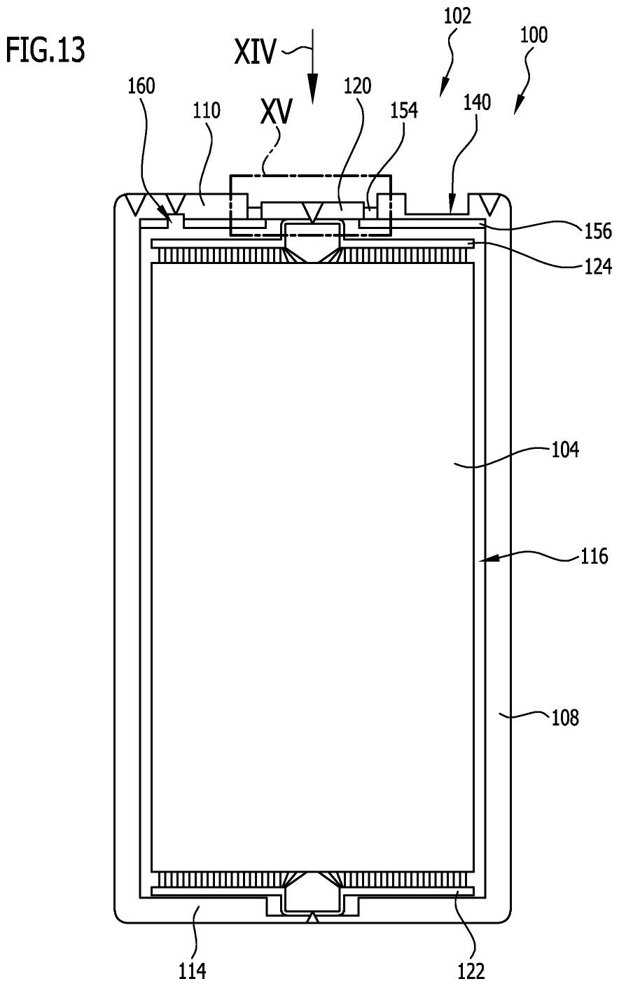

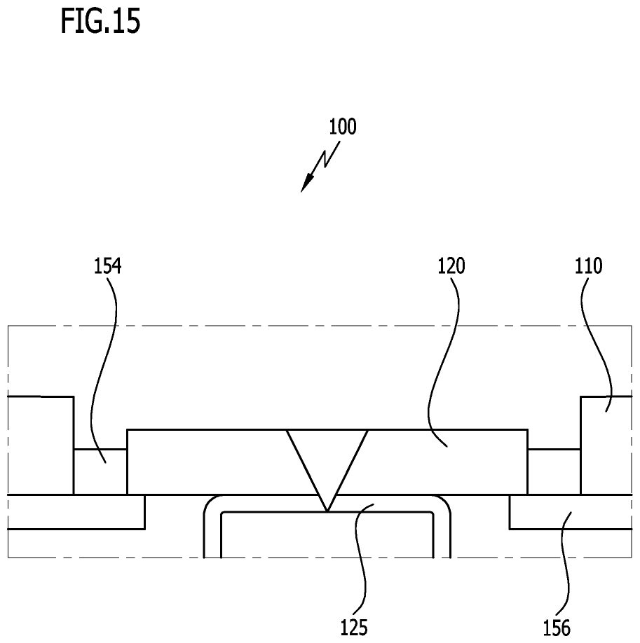

An additional embodiment of an electrochemical cell 100 shown in FIGS. 10 to 15 substantially differs in terms of structure and function from the first embodiment shown in FIGS. 1 to 9 in that the electrochemical cell 100 comprises a second cast element 154 instead of a first cast element 128. The second cast element preferably serves to connect a second cell terminal 120 designed as a second cell terminal to the cover element 110.

In the present case, the second current collector element 124 has a second connecting element 125. In the present case, the second connecting element 125 is designed in the form of a bulge pointing in the direction of the second cell terminal 120 and/or in the form of a projection pointing in the direction of the second cell terminal 120. For example, the second connecting element 125 is impressed into the second current collector element 124. In a cross-section taken parallel to a main extension plane of the second current collector element 124, the second connecting element 125 is preferably at least approximately round.

For example, it is conceivable that the second connecting element 125 of the second current collector element 124 is a bowl-shaped and/or cup-shaped region of the second current collector element 124. Preferably, the second current collector element 124 is largely plate-shaped, for example over approximately 90% of its surface or more. For example, the second current collector element 124 is a current collector plate.

The second current collector element 124 of the additional embodiment shown in FIGS. 10 to 15 preferably has the features and/or advantages of the first current collector element 122 of the first embodiment of the electrochemical cell 100 shown in FIGS. 1 to 9.

Preferably, the second current collector element 124 is material bonded to the second cell terminal 120 in particular by welding, for example through-welding.

Preferably, the first current collector element 122 is integrally bonded to the cup element 108, in particular by welding, for example through-welding.

For example, the first connecting element 123 of the first current collector element 122 is fixed in a depression of the cup element 108.

For example, the wall component 108 comprises aluminum or is formed therefrom. In particular, the cup element 108 is at cathode potential.

For this purpose, it can be provided that the cup element 108 forms the first cell terminal 118. A separate first cell terminal 118 and/or a first cast element 128 are preferably unnecessary. In particular, a first insulating element 130 is dispensable.

It can be advantageous if the cast element 154 comprises or is formed from a first polymer material. For example, the second polymer material comprises a second resin material or is formed therefrom.

It can be beneficial if the second resin material comprises or is formed from one or more of the following materials: epoxide resin material, phenolic resin material, aminoplastic material, polyurethane material, silicone material, polyester resin material, ABS resin material.

It can be advantageous if the second resin material has a hardness of approx. 40 Shore D or more, in particular approx. 50 Shore D, for example approx. 60 Shore D or more, in a cured state to form the second polymer material.

The hardness of the second resin material in a cured state to form the second polymer material is approximately 100 Shore D or less, in particular approximately 97 Shore D or less, for example approximately 95 Shore D or less.

The hardness is determined in particular according to DIN EN ISO 868.

It can be beneficial if the second resin material has a glass transition temperature of approx. 90° C. or more, in particular of approx. 95° C. or more, for example of approx. 100° C. or more. The glass transition temperature is preferably based on a cured state of the second resin material to form the second polymer material.

The second resin material is preferably a one-component resin material, for example a one-component epoxide resin material.

One-component epoxide resin materials preferably have increased stability compared to an electrolyte, which is accommodated in the interior space 116.

It can be advantageous if the second resin material comprises one or more fillers. The one or more fillers are preferably selected from: inorganic fillers, in particular silicon oxide, carbonate, carbide, in particular silicon carbide, nitride, in particular metal nitride, and metal oxide.

Preferred silicon oxides are silicates.

By using fillers, oxygen diffusion and/or water diffusion from an environment of the electrochemical cell 100 into the interior space 116 via the second cast element 154 can be avoided or reduced.

The second cast element 154 preferably has one or more of the features and/or advantages described in connection with the first cast element 128.

In the present case, the electrochemical cell 100 has a second insulating element 156. The second insulating element 156 preferably serves to electrically insulate the second cell terminal 120 from the cover element 110.

In the present case, the second insulating element 156 forms an electrical isolation and/or an electrical insulation between the second cell terminal 120 and the cover element 110. The second insulating element 156 is preferably at least approximately plate-shaped.

The second insulating element 156 preferably serves to electrically insulate the second cell terminal 120. For example, the second insulating element 154 is arranged on an inner side of the cover element 110 facing the interior space 116.

It can be provided that the second insulating element 156 is designed in multiple parts, for example in two parts (not shown).

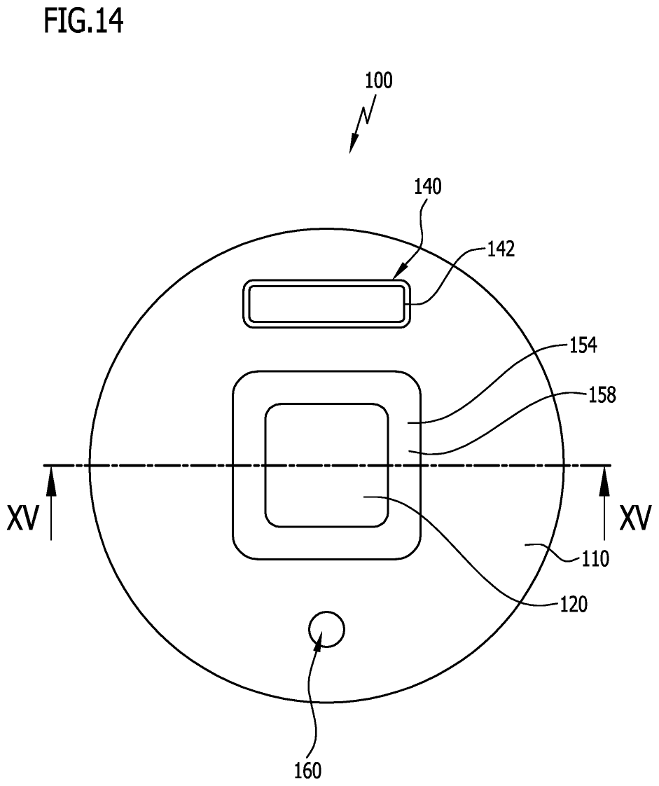

As can be seen in particular in FIG. 14, the second insulating element 156 as a whole preferably has an at least approximately circular cross-section. The cross-section is in particular taken perpendicular to a central axis 132 of the electrochemical cell 100.

According to a preferred embodiment, the second insulating element 156 comprises or is formed from a fourth polymer material.

The fourth polymer material is preferably a thermoplastic polymer material, for example an electrolyte-resistant thermoplastic polymer material.

Additionally or alternatively, the fourth polymer material is, for example, a polymer material that can be processed in an injection molding process.

For example, the fourth polymer material comprises one or more of the following materials: polyethylene terephthalate, polyethylene, polypropylene, polybutylene terephthalate.

It can be advantageous if the second insulating element 156, for example centrally, has a recess in which the second cell terminal 120 is accommodated and/or arranged when the electrochemical cell 100 is in an assembled state.

Preferably, the recess of the second insulating element 156 is at least approximately rectangular in a cross-section taken parallel to the main extension plane of the second insulating element 156.

For example, the second cell terminal 120 and the recess of the second insulating element 130 have, in a cross-section taken perpendicular to the central axis 132 of the electrochemical cell, at least approximately in each case a rectangular shape or a circular shape, for example round and/or oval.

It can be advantageous if the second cell terminal 120 comprises a metallic material, for example copper or is formed therefrom.

As can be seen in particular in FIG. 14, it can be advantageous if the second cell terminal 120 and/or the recess of the second insulating element 156 are at least approximately rectangular with rounded corners in a cross-section taken perpendicular to the central axis 132 of the electrochemical cell 100.

For example, the second cast element 154 forms an annular section 158 between the second cell terminal 120 and the cover element 110.

As can be seen in particular in FIG. 14, it can be advantageous if the second cell terminal 120 is arranged centrally in the cover element 110 and/or the rupture device 140 is arranged facing an edge region of the cover element 110.

In particular, the electrochemical cell 100 has an electrolyte filling opening 160. The electrolyte filling opening 160 is preferably for filling with electrolyte and/or refilling with electrolyte and/or removal of electrolyte.

The electrolyte filling opening 160 is preferably designed as a passage opening in the cover element 110, wherein it can be provided that the electrolyte filling opening 160 is and/or will be closed in a fluid-tight manner after the interior space 116 has been filled. For example, the electrolyte filling opening 160 is welded after filling the electrochemical cell 100.

The cover element 110 and the cup element 108 are preferably materially bonded to one another, for example by welding.

Preferably, the additional embodiment of an electrochemical cell shown in FIGS. 10 to 15 does not have a direct material transition from copper to aluminum or from aluminum to copper.

Otherwise, the embodiment of an electrochemical cell 100 shown in FIGS. 10 to 15 substantially corresponds in its structure and function to the embodiment shown in FIGS. 1 to 9, so that reference is made to the description thereof in this respect.

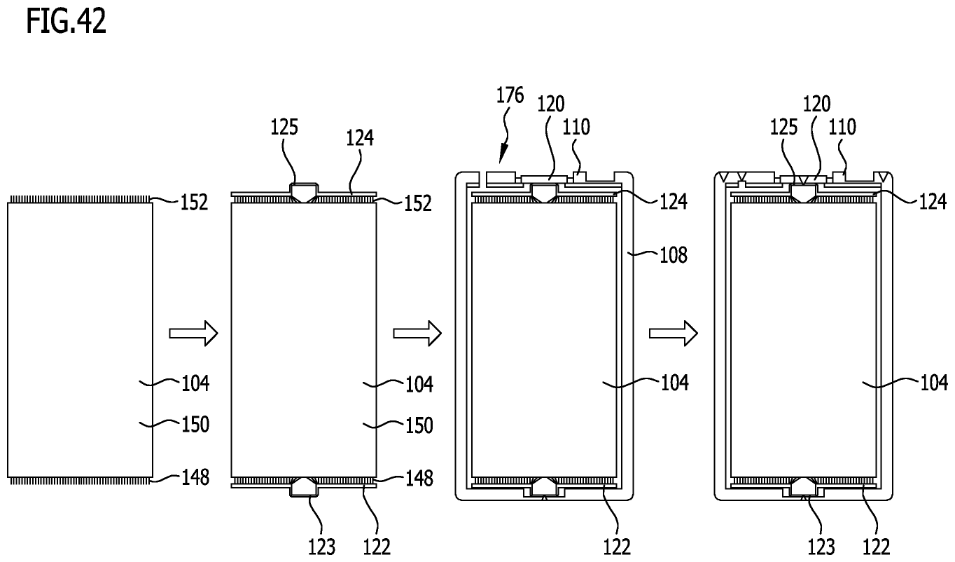

The additional embodiment of an electrochemical cell 100 shown in FIGS. 10 to 15 can be produced, for example, according to the embodiment of a method for producing an electrochemical cell 100 shown in FIGS. 41 and 42.

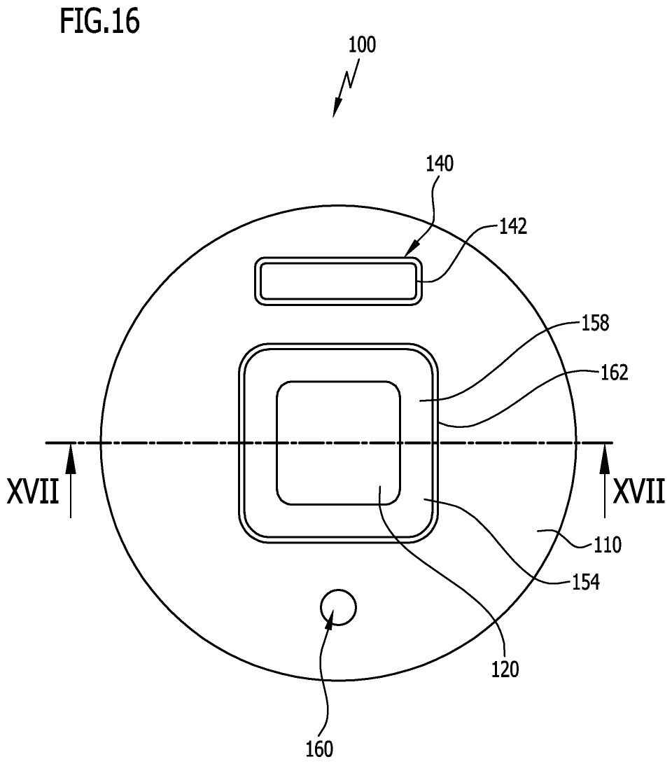

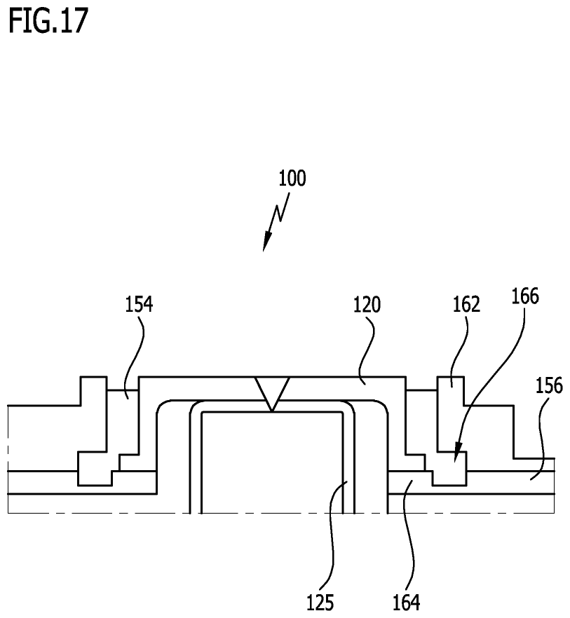

An additional embodiment of an electrochemical cell 100, which is not illustrated in its entirety in FIGS. 16 and 17, substantially differs in terms of structure and function from the embodiment shown in FIGS. 10 to 15 in that the cover element 110 has an elevation 162, which is arranged, for example, circumferentially around an opening in which the second cell terminal 120 is arranged.

It can be advantageous if the elevation 162 projects away from a main body of the cover element 110 in a direction pointing away from the interior space of the electrochemical cell 100. For example, the elevation 162 borders the opening for accommodating the second cast element 154.

The elevation 162 serves in particular to increase the filling level when filling in the second resin material. For example, the elevation 162 is a bead.

As can be seen in particular in FIG. 17, it can be advantageous if the second cell terminal 120 has one or more radial projections 164, which extend along radial directions with respect to the central axis 132 of the electrochemical cell 100. In the present case, the second cell terminal 120 has a single radial projection 164, which is designed to run around the second cell terminal 120. The second cast element 154 can therefore mechanically interlock with the second cell terminal 120.

With regard to the cover element 110, it can be advantageous if the cover element 110 has one or more recesses 166 in which the second cast element engages behind the cover element when the electrochemical cell 100 is in an assembled state along a direction running parallel to the central axis 132. In the present case, a circumferential recess 166 is provided by which in particular an undercut is formed.

Otherwise, the embodiment of an electrochemical cell 100 shown in FIGS. 16 and 17 substantially corresponds in its structure and function to the embodiment shown in FIGS. 10 to 15, so that reference is made to the description thereof in this respect.

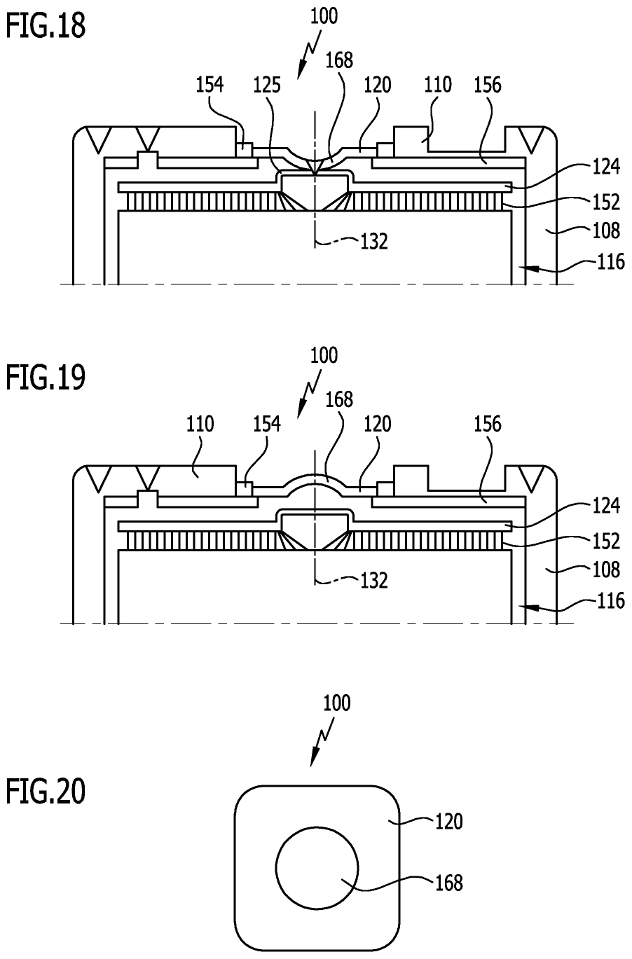

An additional embodiment of an electrochemical cell 100, which is not illustrated in its entirety in FIGS. 18 to 20, substantially differs in terms of structure and function from the embodiment shown in FIGS. 10 to 15 in that the second cell terminal 120 comprises a snap-around element 168 or is designed as a snap-around element 168 as a whole.

For example, the second cell terminal forms a so-called “current interruption device” (CID). FIG. 18 shows a resting state of the snap-on element 168. FIG. 19 shows a triggered state of the snap-on element 168. In the resting state of the snap-on element 168, the second cell terminal 120 and the second current collector element 124 are electrically conductively connected to one another.

When a critical pressure and/or a critical temperature is exceeded in the interior space 116 of the electrochemical cell 100, the snap-on element 168 is preferably deflected outwards from the resting state to the released state. By deflecting the snap-on element 168 toward the outside away from the interior space 116 of the electrochemical cell 100, an electrical contact between the second cell terminal 120 and a second current collector element 124 is preferably interrupted and/or disconnected.

By deflecting the at least one snap-on element 168 from the resting state into the triggered state, in particular an electrically conductive connection between the second cell terminal 120 and the second current collector element 124, which is connected to the electrochemical element 104, is separated.

The snap-on element 168 is preferably formed by the second cell terminal as a whole. For example, the second cell terminal 120 is curved.

Alternatively, the at least one snap-on element 168 can, for example, be welded into a main body of the second cell terminal 120 of the electrochemical cell.

As can be seen in particular in FIG. 20, the snap-on element 168 preferably has an at least approximately circular cross-section. The cross-section is preferably taken perpendicular to the central axis 132 of the electrochemical cell 100.

Otherwise, the embodiment of an electrochemical cell 100 shown in FIGS. 18 to 20 substantially corresponds in its structure and function to the embodiment shown in FIGS. 10 to 15, so that reference is made to the description thereof in this respect.

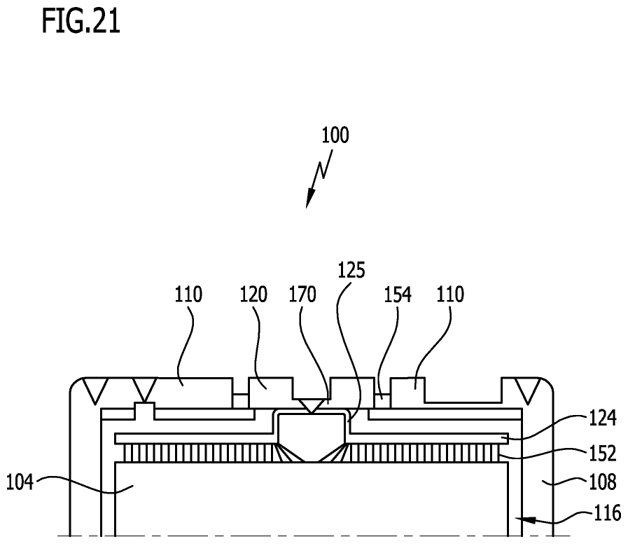

The additional embodiment of an electrochemical cell 100 not illustrated as a whole in FIG. 21 substantially differs in terms of structure and function from the embodiment shown in FIGS. 10 to 15 in that the second cell terminal 120 has a region of reduced material thickness 170.

The region of reduced material thickness 170 serves in particular to facilitate a connectability of the second cell terminal 120 to the second current collector element 124. The region of reduced material thickness 170 is, for example, a low embossed region. In the region of reduced material thickness 170, the second cell terminal 120 preferably has a reduced through-welded depth.

For example, the material thickness in the region of reduced material thickness 170 is approximately 20% or more, for example approximately 30% or more, less than an average material thickness in the other regions of the second cell terminal 120.

Otherwise, the embodiment of an electrochemical cell 100 shown in FIG. 21 substantially corresponds in its structure and function to the embodiment shown in FIGS. 10 to 15, so that reference is made to the description thereof in this respect.

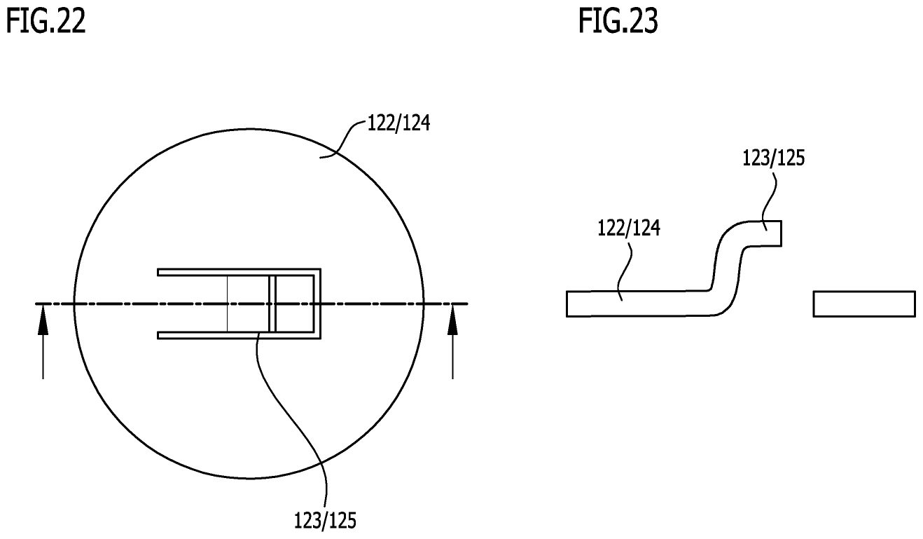

FIGS. 22 and 23 show a variant of a current collector element. The current collector element can form a first current collector element 122 and/or a second current collector element 124.

In the present case, the first connecting element 123 or the second connecting element 125 is formed by a cut-out contour. For example, a region forming the first connecting element 123 or the second connecting element 125 is bent away from a main body of the current collector element 122/124. For example, the particular connecting element 123/125 is at least approximately L-shaped in a cross section taken perpendicular to the main extension plane of the main body of the particular current collector element 122/124.

For example, the first connecting element 123 or the second connecting element 125 is formed by punching.

A tolerance compensation element is preferably formed by the cut-out region, for example the punched-out region.

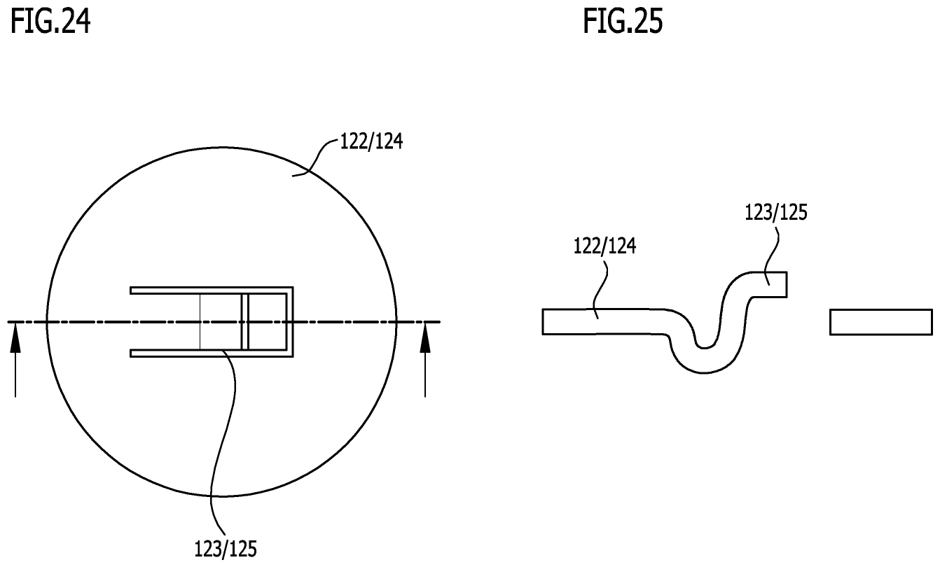

An additional variant of a first current collector element 122 or of a second current collector element 124 shown in FIGS. 24 and 25 substantially differs in terms of structure and function from the variant shown in FIGS. 22 and 23 in that the first connecting element 123 or the second connecting element 125 is connected to the main body of the particular current collector element 122/124 by a transition at least approximately U-shaped in a cross-section.

Moreover, the variant of a current collector element 122/124 shown in FIGS. 24 and 25 corresponds to the variant shown in FIGS. 22 and 23, so that reference is made to the description thereof in this respect.

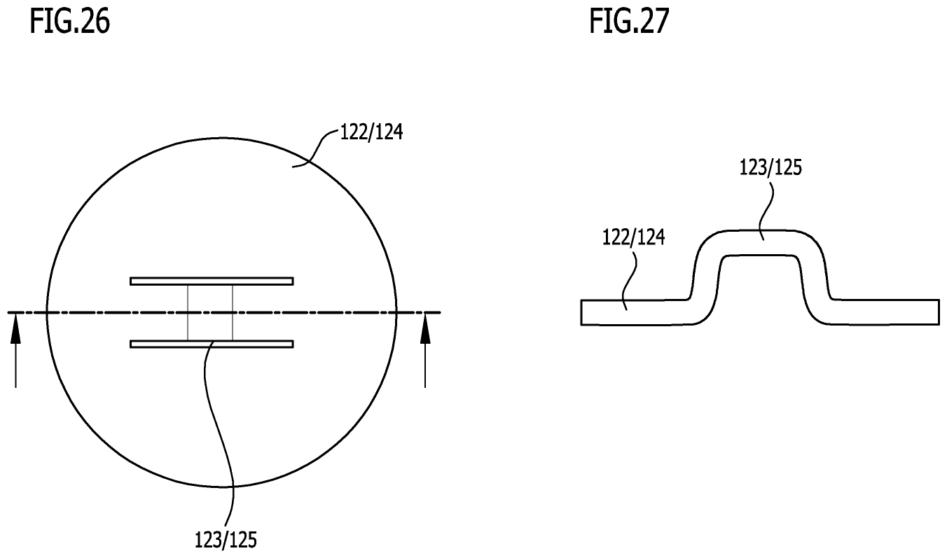

An additional variant of a first current collector element 122 or of a second current collector element 124 shown in FIGS. 26 and 27 substantially differs in terms of structure and function from the variant shown in FIGS. 22 and 23 in that the first connecting element 123 or the second connecting element 125 is at least approximately bowl-shaped and/or cup-shaped. The first current collector element 122 or the second current collector element 124 is preferably designed free of openings.

Moreover, the variant of a current collector element 122/124 shown in FIGS. 26 and 27 corresponds to the variant shown in FIGS. 22 and 23, so that reference is made to the description thereof in this respect.

The variants of the current collector elements 122/124 shown in FIGS. 22 to 27 can be used in all the embodiments of an electrochemical cell 100 described above and below. Variants different from one another can also be combined with one another in one embodiment.

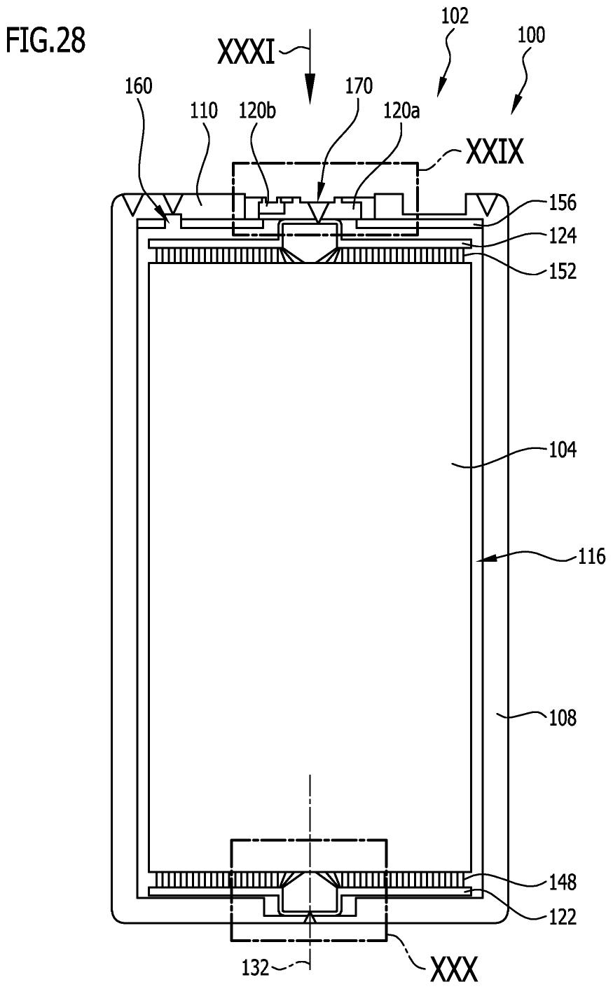

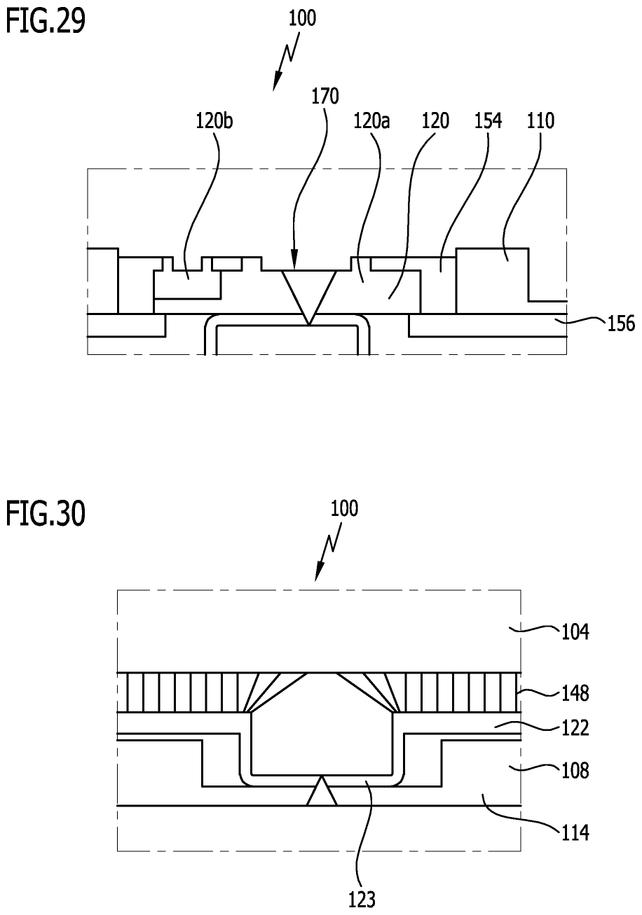

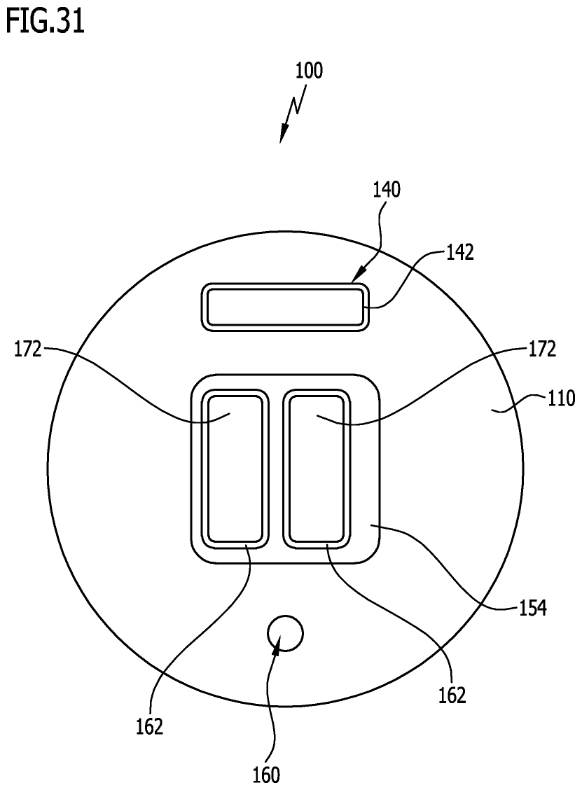

The additional embodiment of an electrochemical cell 100 that is shown in FIGS. 28 to 31 substantially differs in terms of structure and function from the embodiment shown in FIG. 21 in that the second cell terminal 120 is designed in multiple parts, in this case two parts. In the present case, a first part 120a forms a carrier part in which a second part 120b of the second cell terminal 120 is accommodated.

In the present case, the first part 120a and the second part 120b of the second cell terminal 120 are formed from different metallic materials. A material transition within the second cell terminal 120 is thereby formed.

In the present case, the first part 120a of the second cell terminal 120 comprises copper or is formed therefrom.

Preferably, the second cell terminal 120 comprises two functional regions 172, which are formed by the first part 120a and the second part 120b.

The first part 120a preferably forms a connection and/or welding region in which the second cell terminal 120 is connected to the second current collector element 124.

In the present case, the second part 120b comprises aluminum or is formed therefrom.

In the present case, the second part 120b is arranged on a side of the second cell terminal 120 facing away from the interior space 116 of the electrochemical cell 100.

Preferably, the two functional regions 172 are surrounded by elevations 162 of the cover element 110 and/or surrounded by the second cast element 154.

Otherwise, the additional embodiment of an electrochemical cell 100 shown in FIGS. 28 to 31 substantially corresponds in its structure and function to the embodiment shown in FIG. 21, so that reference is made to the description thereof in this respect.

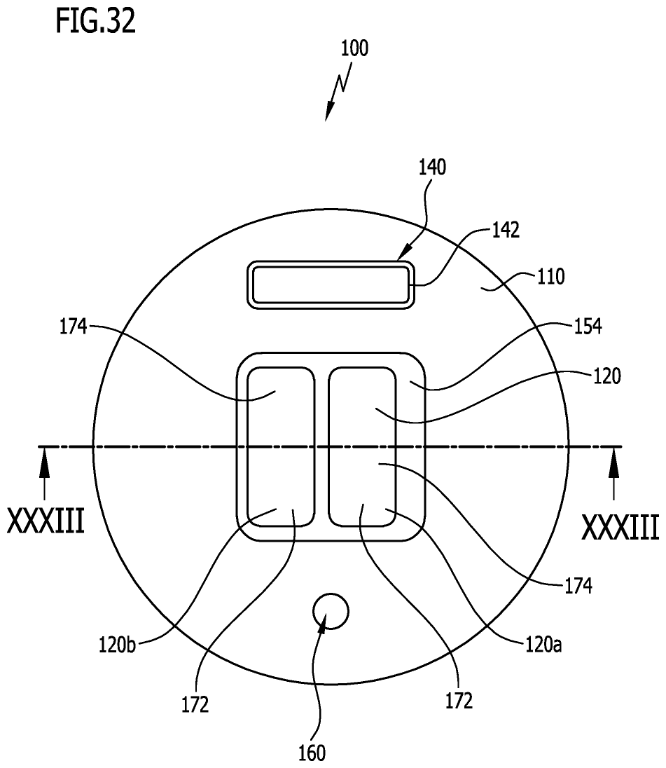

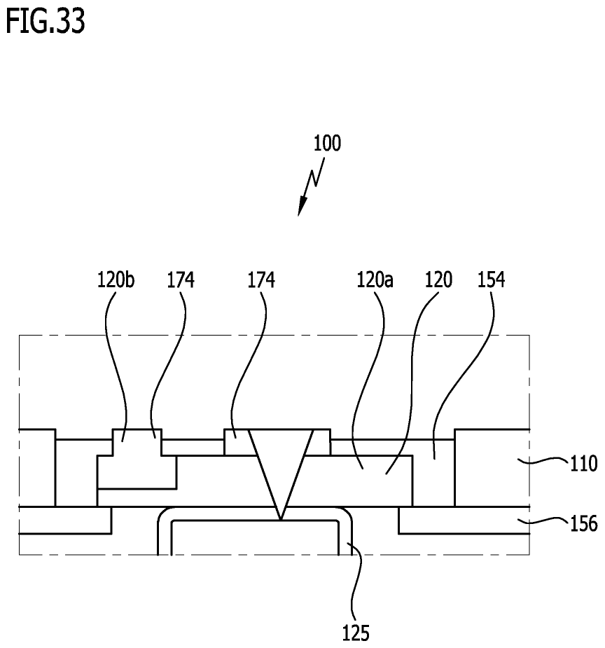

An additional embodiment of an electrochemical cell 100, which is not illustrated in its entirety in FIGS. 32 and 33, substantially differs in terms of structure and function from the embodiment shown in FIGS. 28 to 31 in that the first part 120a and the second part 120b are formed at least partially by elevations 174.

Elevations 162 of the cover element 110 are in particular unnecessary.

Otherwise, the additional embodiment of an electrochemical cell 100 shown in FIGS. 32 to 33 substantially corresponds in its structure and function to the embodiment shown in FIGS. 28 to 31, so that reference is made to the description thereof in this respect.

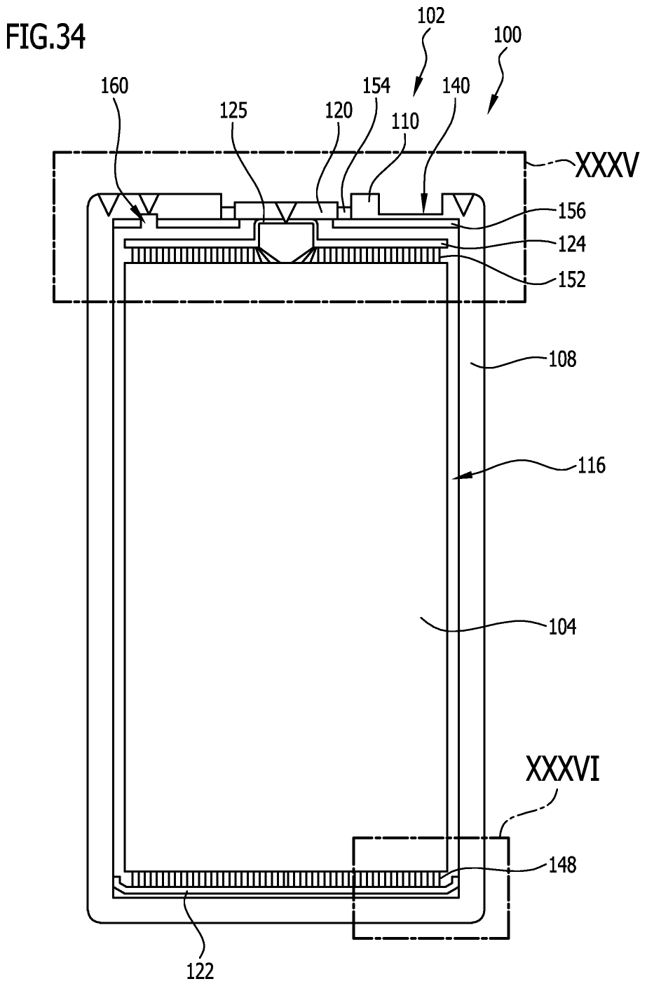

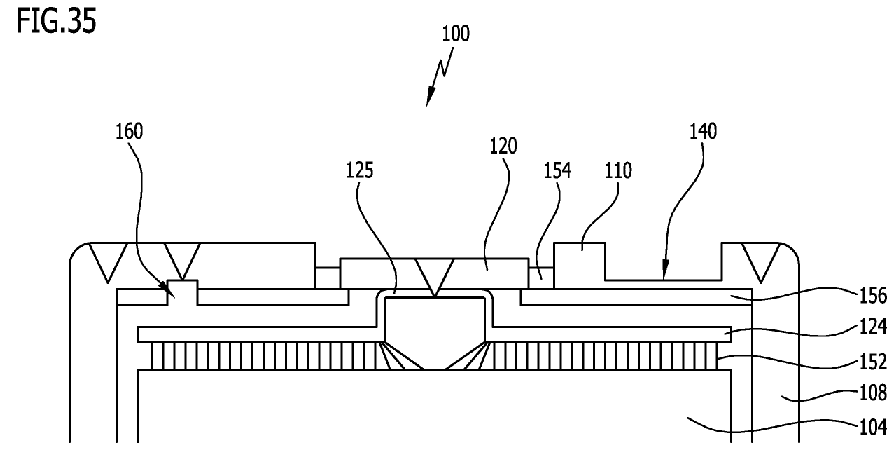

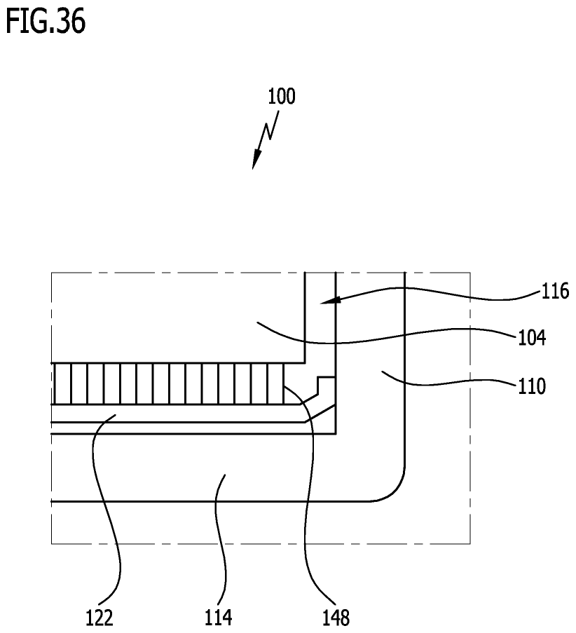

The additional embodiment of an electrochemical cell 100 shown in FIGS. 34 to 36 differs in its structure and function from the embodiment shown in FIGS. 10 to 15 in that the first current collector element 122 is pressed into the cup element 110.

A direct material transition from aluminum to copper or vice versa is in particular not provided.

For example, the first current collector element 122 is designed curved toward the edge, wherein the edge of the first current collector element 122 is preferably curved away from the bottom section 114.

Otherwise, the additional embodiment of an electrochemical cell 100 shown in FIGS. 34 to 36 substantially corresponds in its structure and function to the embodiment shown in FIGS. 10 to 15, so that reference is made to the description thereof in this respect.

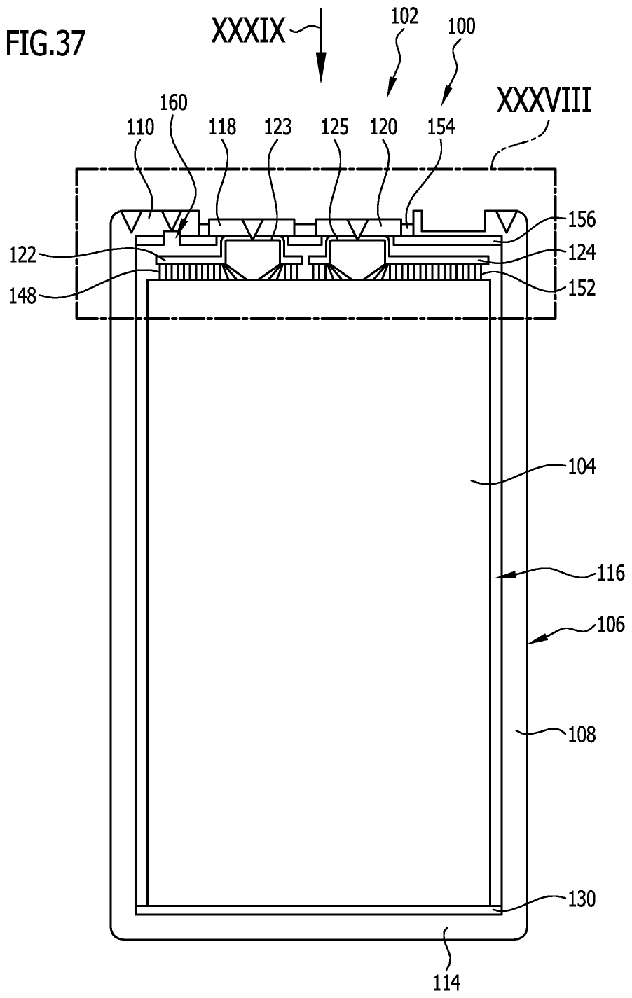

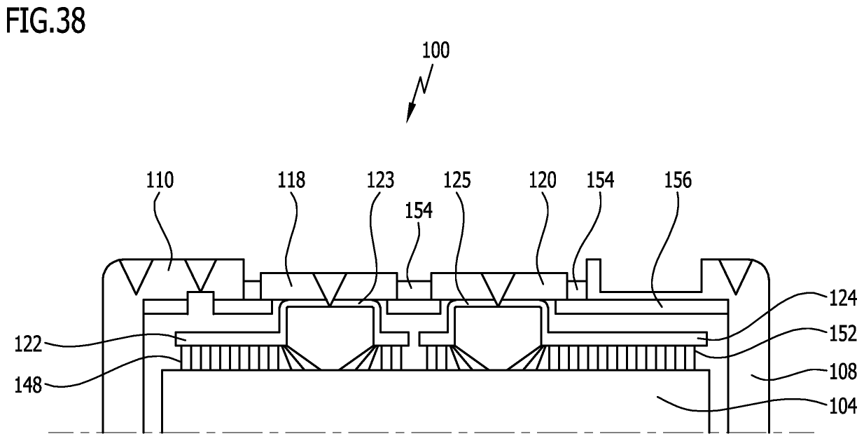

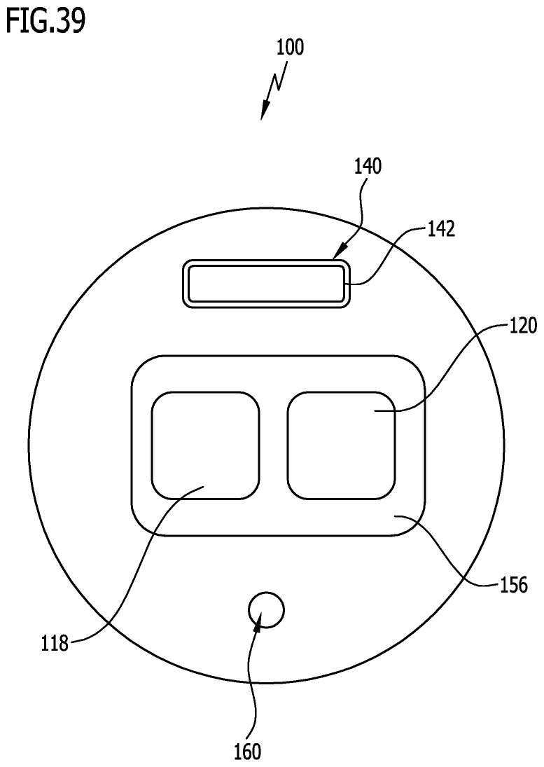

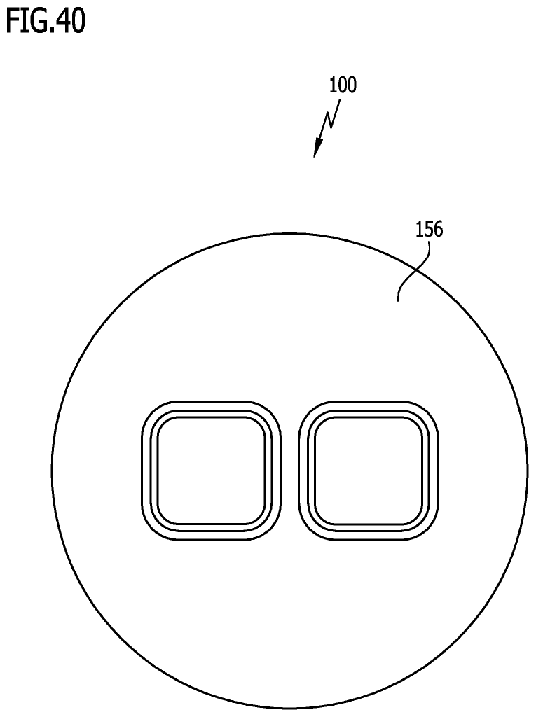

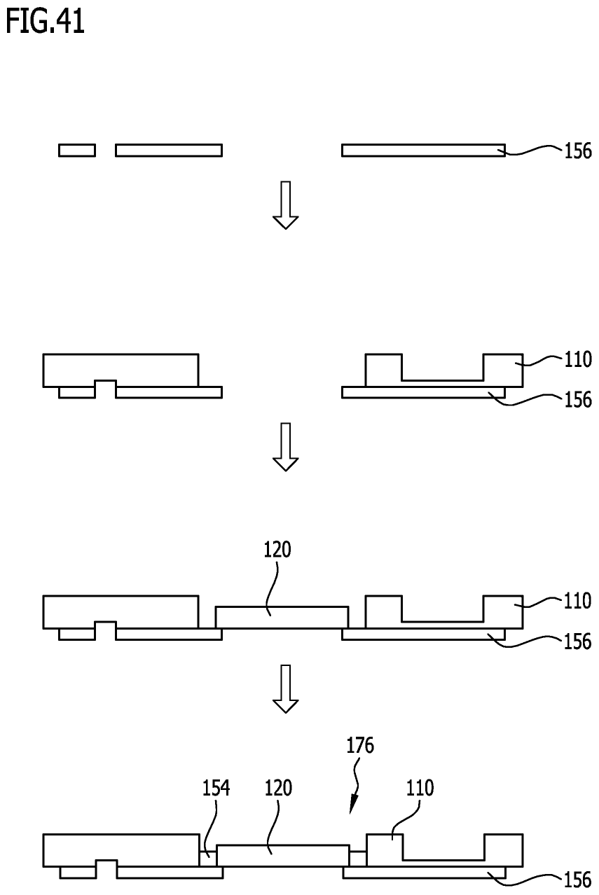

An additional embodiment of an electrochemical cell 100 shown in FIGS. 37 to 40 substantially differs from the first embodiment shown in FIGS. 1 to 9 in terms of structure and function in that both the first cell terminal 118 and the second cell terminal 120 are designed as cell terminals separate from the housing 106, and the first cell terminal 118 and the second cell terminal 120 are embedded in a common cast element 154.

The cup element 108 and the cover element 110 are and/or will be connected to one another by welding in the present case. For this purpose, reference is made to the relevant designs of the embodiment shown in FIGS. 10 to 15.

Both cell terminals, the first cell terminal 118 and the second cell terminal 120, are accommodated in an opening of the cover element 110 introduced into the cover element 110.

In the present case, the first current collector element 122 and the second current collector element 124 are arranged on a side of the electrochemical element 104 facing the cover element 110. For example, the first current collector element 122 and the second current collector element 124 are arranged next to one another and at the same distance from the cover element 110.

In the present case, the first current collector element 122 has an at least approximately bowl-shaped and/or cup-shaped first connecting element 123, which is materially bonded to the first cell terminal 118, for example by welding.

In the present case, the second current collector element 124 has an at least approximately bowl-shaped and/or cup-shaped second connecting element 125, which is connected to the second cell terminal 120 by material bonding, for example by welding.

A weld seam between the particular connecting element 123, 125 and the cell terminal 118, 120 is preferably fluid-tight.

The electrolyte filling opening 160 is preferably closed by welding after filling the housing 106 with electrolyte.

The first cell terminal 118 and the second cell terminal 120 are preferably electrically separated from one another by the cast element 154 and embedded in the polymer material of the cast element 154.

It can be beneficial if a second insulating element 156 of the electrochemical cell 100 is arranged adjacent to the cover element 110 and serves to electrically insulate the cell terminals 118, 120, and/or the interior space 116 of the electrochemical cell 100.

The second insulating element 156 preferably has a recess and a plurality of depressions in the form of beads. In terms of structure and function, these correspond to the recess 134 and the depressions 136a and 136b, which were described in connection with the first insulating element 130 of the first embodiment (see FIG. 7), so that reference is made to the corresponding explanations. In the present case, there is a recess and corresponding depressions in the form of beads for each cell terminal 118, 120.

It can be beneficial if a first insulating element 130 is arranged directly adjacent to the bottom section 114 of the cup element 108.

Otherwise, the additional embodiment of an electrochemical cell 100 shown in FIGS. 37 to 40 corresponds substantially in its structure and function to the first embodiment shown in FIGS. 1 to 9, so that reference is made to the description thereof in this respect.

FIGS. 41 and 42 show an embodiment of a method for producing an electrochemical cell, for example an electrochemical cell 100 according to FIGS. 10 to 15.

Preferably, a cover element assembly 176 is produced first (see FIG. 41). For this purpose, for example, the second insulating element 156, the cover element 110 and the second cell terminal 120 are stacked.

Subsequently, for example, the second resin material is cast and/or filled into a region between the second cell terminal 120, the cover element 110, and/or the second insulating element 156 in a flowable state.

During and/or after a filling, the second resin material is cured and/or dried, whereby in particular the second cast element 154 is formed.

As shown in particular in FIG. 42, an electrochemical element 104 is preferably provided or produced, which has first contacting projections 148 and second contacting projections 152 that project away from the main body 150 of the electrochemical element 104 on opposite sides thereof.

The first contacting projections 148 are preferably materially bonded, for example welded, to the first current collector element 122.

In particular, the second contacting projections 152 are materially bonded, for example welded, to the second current collector element 124.

Subsequently, a component arising from the steps described above is inserted into the cup element 108, and the cover element assembly 176 is mounted and/or positioned relative to the cup element 108.

Preferably, the first current collector element 122 is materially bonded to the cup element 108 at its first connecting element 123, for example welded thereto.

In particular, the cover element 110 and the cup element 108 are materially bonded to one another, for example welded to one another, beforehand, during or after.

It can be beneficial if the second current collector element 124 is materially bonded to the second cell terminal 120, for example welded thereto, at its second connecting element 125.

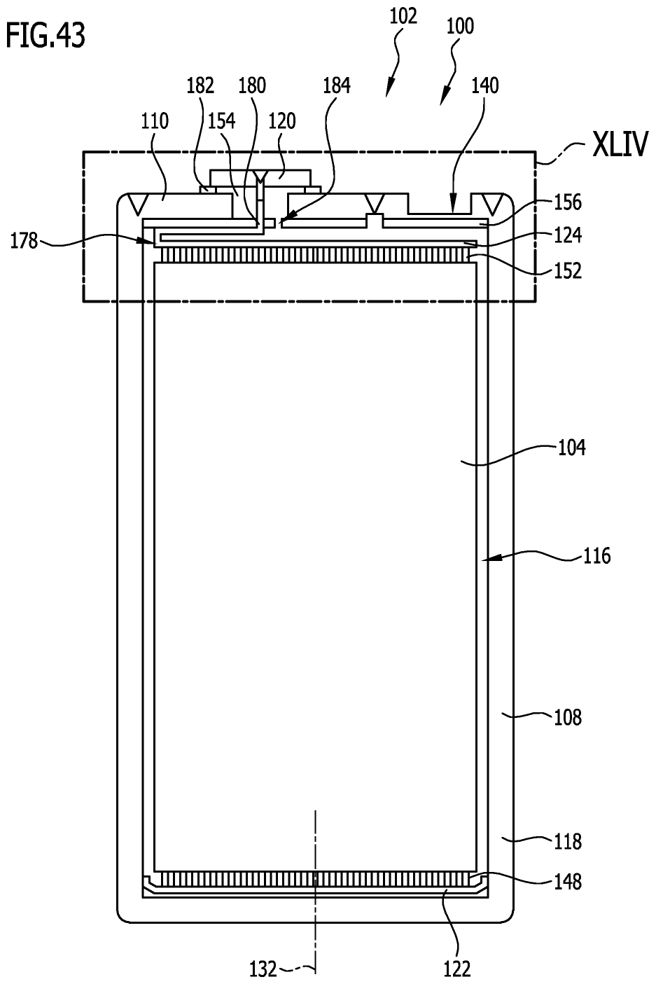

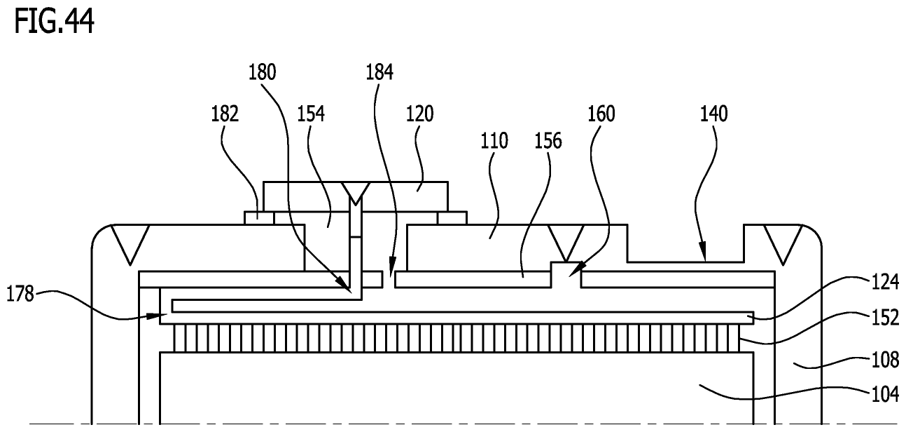

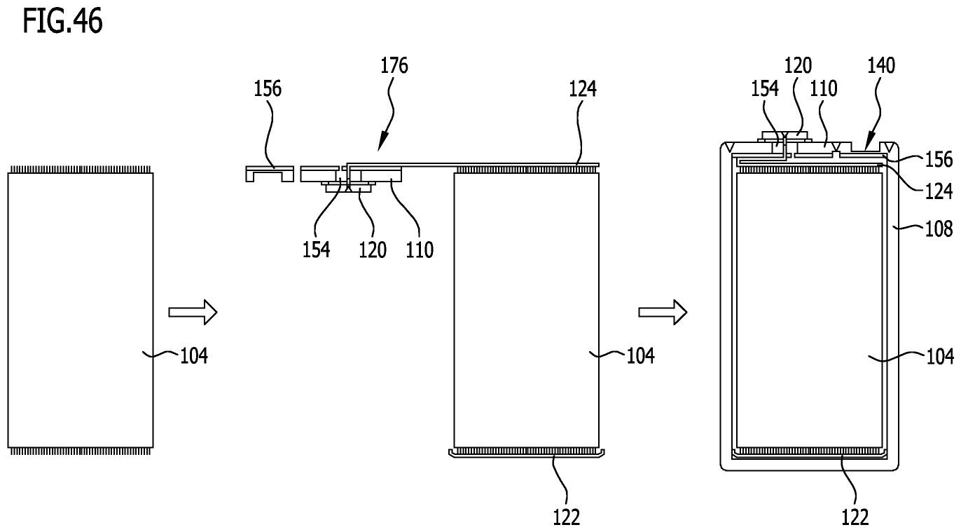

FIGS. 43 to 46 show another embodiment of an electrochemical cell 100 and an embodiment of a method for producing the same.

The additional embodiment of an electrochemical cell 100 shown in FIGS. 43 to 46 substantially differs in its structure and function from the embodiment illustrated in FIGS. 34 to 36 in that the second current collector element 124 has a first bend 178 of approximately 180° and a second bend 180 of approximately 90°.

The second current collector element 124 forms, for example, a current lug.

The second cell terminal 120 is preferably arranged eccentrically.

It can be beneficial if the electrochemical cell 100 has a spacer element 182, which is arranged between the second cell terminal 120 and the cover element 110. In particular, the spacer element 182 radially borders the second cast element 154.

Preferably, the second insulating element 156 has an opening that forms a resin material filling opening 184 for filling in the resin material.

A current collector element/cup element compression is preferably present with respect to the first current collector element 122. This was described in connection with the embodiment shown in FIGS. 34 to 36.

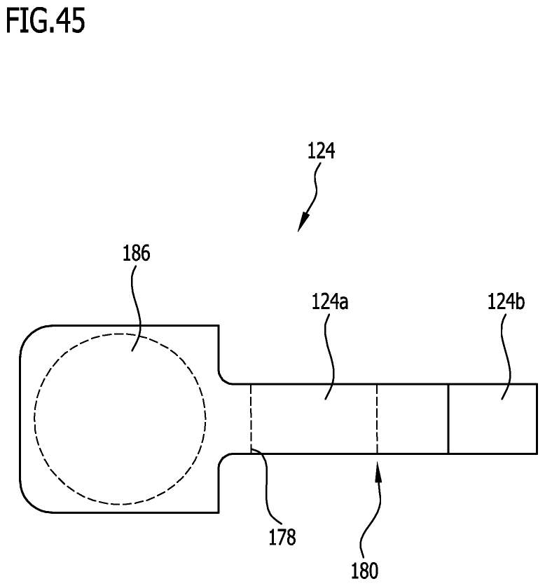

As can be seen in particular in FIG. 45, the second current collector element 124 preferably has a connection region 186 which, in particular, serves to connect to the second contacting projections 152, for example by welding.

Bending lines at which the first bend 178 and the second bend 180 are generated are indicated in FIG. 45 by dashed lines.

In particular, the second current collector element 124 comprises two current collector element parts 124a, 124b, which are formed from different metallic materials.

For example, a first current collector element part 124a, which is and/or will be connected to the second contacting projections 152, comprises copper or is formed therefrom.

Preferably, a second current collector element part 124b, which is and/or will be connected to the second cell terminal 120, comprises aluminum or is formed therefrom.

The second current collector element part 124b is preferably materially bonded to the second cell terminal 120, for example welded.

For producing the electrochemical cell 100 according to FIGS. 43 to 45, an electrochemical element 104, as described in connection with the other methods, is preferably provided or produced.

Subsequently, the first current collector element 122 and the second current collector element 124 together with a cover element assembly 176 are materially bonded to the electrochemical element 104, for example welded.

To produce the cover element assembly 176, the second insulating element 156, the second cell terminal 120, and the second current collector element 124 are preferably stacked, and the second resin material is filled in through the resin material filling opening 184. The second resin material is then preferably cured and/or dried, whereby in particular the second cast element 154 is formed.

Subsequently, the second current collector element 124 is preferably bent twice, whereby, for example, the first bend 178 and the second bend 180 are formed.

A resulting component is inserted into the cup element 108, and the cup element 108 and the cover element 110 are preferably materially bonded to one another, for example welded to one another.

After filling in the electrolyte, the electrolyte filling opening 160 is preferably sealed, for example welded, in a fluid-tight manner.

Otherwise, the additional embodiment of an electrochemical cell 100 shown in FIGS. 43 to 46 substantially corresponds in its structure and function to the one in FIGS. 34 to 36, so that reference is made to the description thereof in this respect.

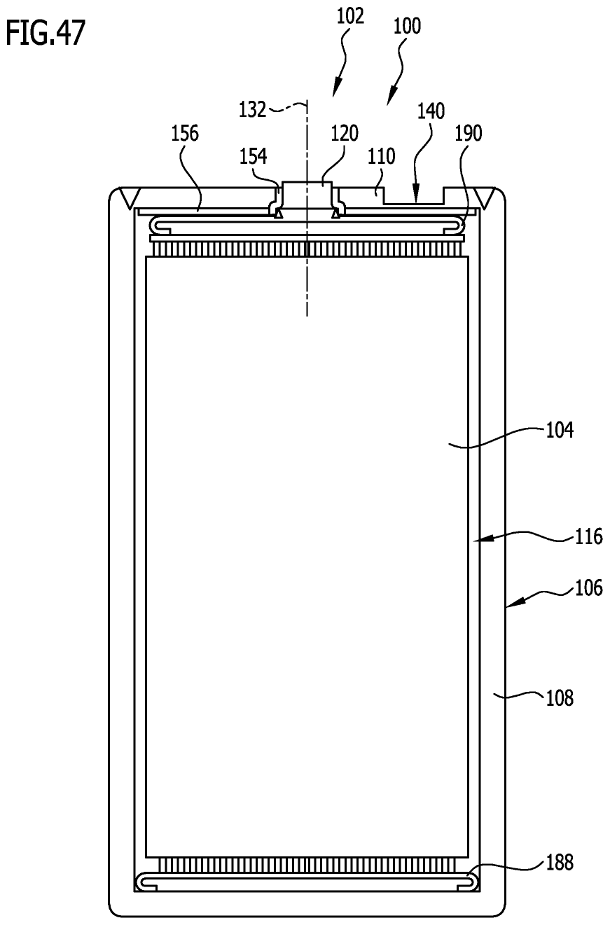

An additional embodiment of an electrochemical cell 100 shown in FIG. 47 substantially differs in its structure and function from the embodiment shown in FIGS. 34 to 36 in that the first connecting element 123 is a first spring element 188, and/or the second connecting element 125 is a second spring element 190.

The first spring element 188 and/or the second spring element 190 preferably enable suspension in a direction running parallel to the central axis 132 of the electrochemical cell 100.

The electrochemical element 104 is preferably frictionally connected to the bottom section 114 of the cup element 108 via the first spring element 188. The first spring element 188 is in particular a spring washer. For example, the first spring element 188 comprises or is formed from aluminum.

It can be advantageous if the electrochemical element 104 is frictionally connected to the second cell terminal 120 via the second spring element 190. In particular, the second spring element 190 is a spring washer. For example, the spring element 190 comprises copper or is formed therefrom.

It can be provided that the second spring element 190 is materially bonded to the second cell terminal 120, for example by welding.

For example, the second spring element 190 is welded to the second cell terminal 120 at its free ends.

For fixing purposes, it can be beneficial if the second cell terminal 120 comprises an aluminum-copper pin or is formed therefrom. For example, a frictional tab connection is formed.

Otherwise, the additional embodiment of an electrochemical cell 100 shown in FIG. 47 substantially corresponds in its structure and function to the one in FIGS. 34 to 36, so that reference is made to the description thereof in this respect.

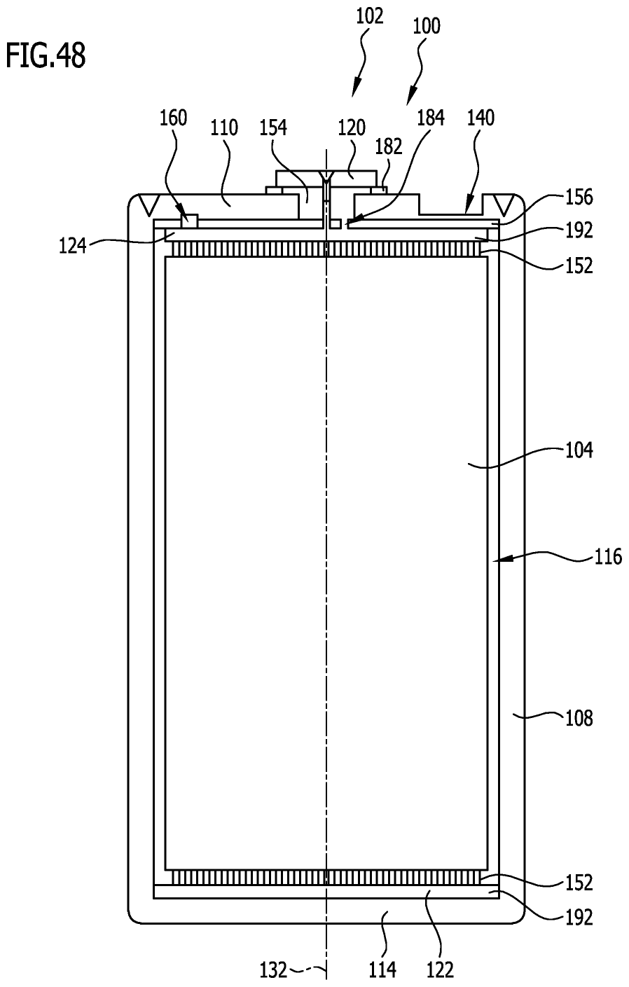

An additional embodiment of an electrochemical cell 100 shown in FIG. 48 substantially differs in its structure and function from the embodiment shown in FIGS. 34 to 36 in that the first current collector element 122 and/or the second current collector element 124 have an electrically conductive coating 192.

The coating 192 is preferably electrolyte-resistant.

It may be advantageous if a frictional connection is and/or will be generated between the first current collector element 122 and the cup element 108 by pressing in the first current collector element 122.

Preferably, the electrically conductive and/or electrolyte-resistant coating 192 comprises or is formed from an electrically conductive fluoropolymer material or a synthetic rubber material.

Preferably, a first coating material of the coating 192 of the first current collector element 122 and a second coating material of the coating 192 of the second current collector element 124 are identical.

Alternatively, different coating materials that are different from each other can be used.

Electrically conductive fluoropolymer materials and/or synthetic rubber materials are preferably used as the first coating material and/or as the second coating material.

For example, the following compositions are suitable as the first coating material or as the second coating material for the electrically conductive and/or electrolyte-resistant coating 192:
a1) a resin material and one or more electrically conductive additives, for example an epoxide resin material and one or more conductive carbon blacks;
a2) an elastomer material and a transition metal carbide, and optionally one or more electrically conductive additives, for example ethylene-propylene-diene rubber or styrene-butadiene rubber and titanium carbide;
a3) an electrically conductive adhesive material, preferably an elastomer material, a resin material, one or more electrically conductive additives, and optionally a transition metal oxide, for example ethylene-propylene-diene rubber or styrene-butadiene rubber, an epoxide resin material, conductive carbon black, and optionally titanium carbide;
a4) an electrically conductive thermoplastic material, in particular a thermoplastic material, one or more electrically conductive additives, and a transition metal oxide, for example polyvinylidene fluoride or polytetrafluoroethylene and conductive carbon black and titanium carbide;
a5) an electrically conductive paste, for example comprising styrene-butadiene rubber, carboxymethyl cellulose, titanium carbide, wherein optionally a fluoropolymer suspension can be used.

The aforementioned materials can in particular be referred to as follows:
a1) electrically conductive casting resin;
a2) electrically conductive elastomer;
a3) an electrically conductive adhesive;
a4) an electrically conductive thermoplastic material;
a5) an electrically conductive paste.

In the production of the electrochemical cell 100, it can be provided that the second resin material of the second cast element 154 and a coating material of the coating 192 are simultaneously cured and/or dried.

The electrochemical cell 100 preferably has a spacer element 182 as described in connection with FIGS. 43 to 46.

Otherwise, the embodiment of an electrochemical cell 100 shown in FIG. 48 substantially corresponds in its structure and function to the embodiment shown in FIGS. 34 to 36, so that reference is made to the description thereof.

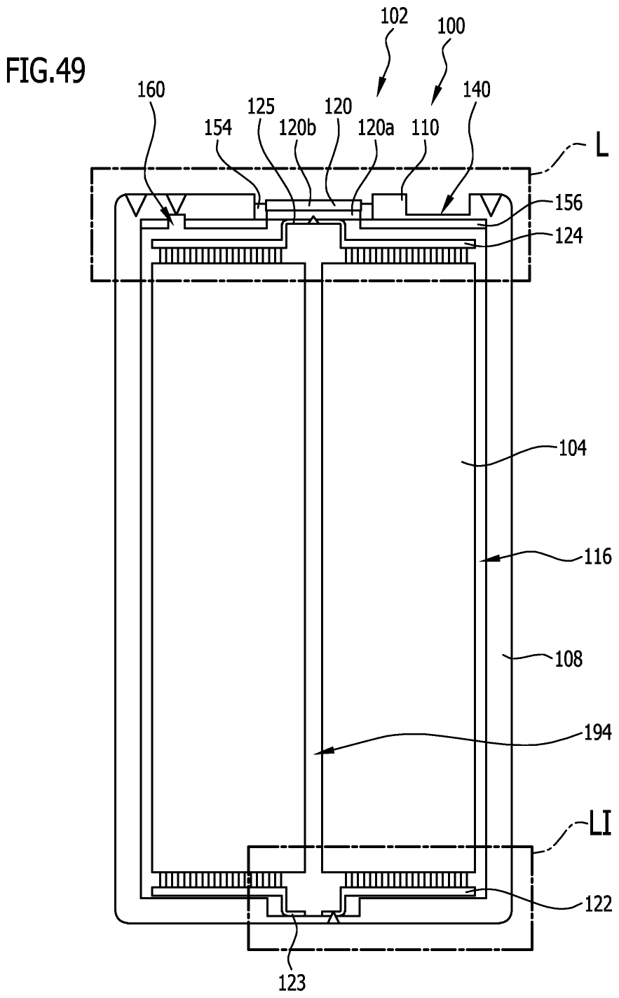

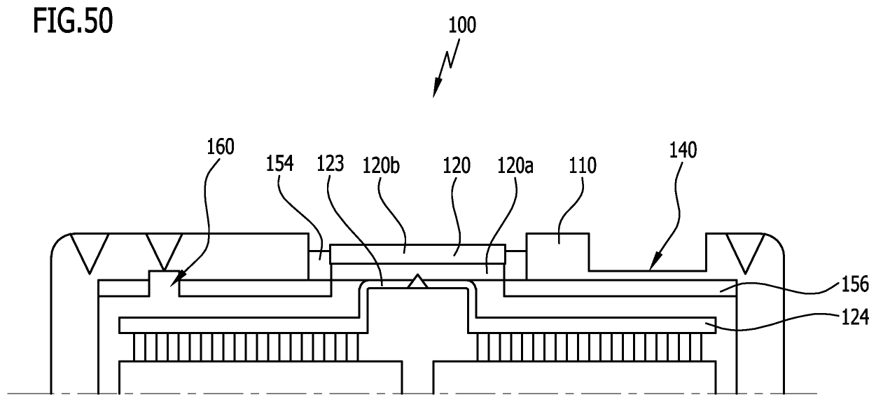

FIGS. 49 to 52 show another embodiment of an electrochemical cell 100 and an embodiment of a method for producing the same.

With regard to structure and function, the embodiment of an electrochemical cell 100 shown in FIGS. 49 to 52 substantially differs from the embodiment shown in FIGS. 28 to 31 in that a connection of the second current collector element 124 and the second cell terminal 120 by a weld is formed by an at least approximately cylindrical cavity 194 in the electrochemical element 104.

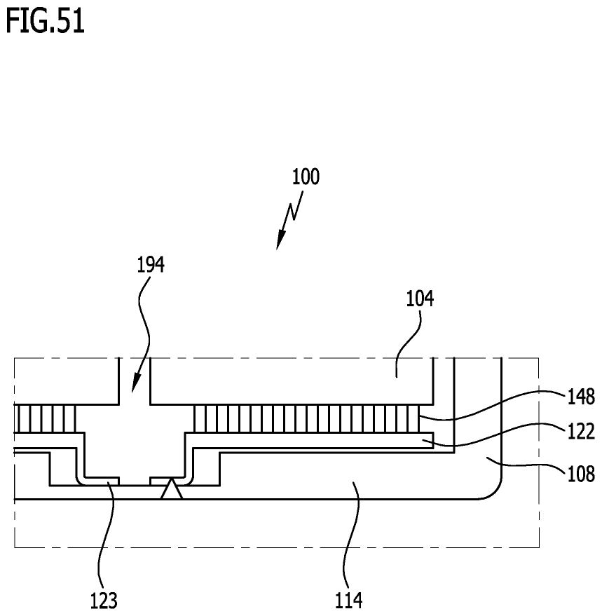

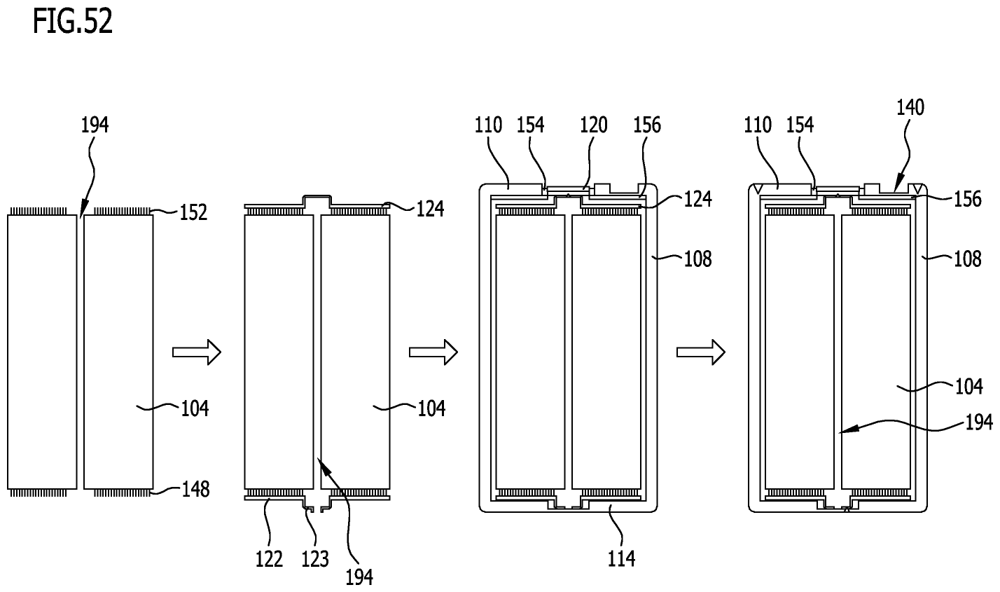

The electrochemical element 104 as a whole is preferably designed to be at least approximately hollow-cylindrical. The cavity 194 is preferably created by a winding device or as soon as it is removed. The winding device is preferably a winding mandrel about which a substrate, which forms the electrochemical element 104, is wound (see method according to FIG. 52, wherein the winding itself is not shown in the drawing).

The first part 120a and the second part 120b of the second cell terminal 120 are preferably arranged one behind the other along a direction running parallel to the central axis 132, and in particular have at least approximately the same dimensions.

It can be beneficial if a material transition within the second cell terminal 120 is covered by the second cast element 156 and/or is embedded in the second cast element.

The first connecting element 123 of the first current collector element 122 preferably has an opening at an end facing the bottom section 114.

In order to produce the electrochemical cell, the electrochemical element 104 is preferably generated or provided, and the first current collector element 122 and the second current collector element 124 are welded.

Subsequently, the cover element assembly is preferably mounted, and the second current collector element 124 and the second cell terminal 120 are welded to one another, for example, through the cavity 194 in the electrochemical element 104.

The welding is preferably carried out by laser welding or resistance welding with a long rod-shaped electrode.

A resulting assembly is then preferably inserted into the cup element 108, and the cover element 110 and the cup element 108 are material-bonded to one another, for example welded.

For example, electrolyte is then filled in, and then the electrolyte filling opening 160 is welded.

Otherwise, the additional embodiment of an electrochemical cell 100 shown in FIGS. 49 to 52 corresponds substantially in its structure and function to the first embodiment shown in FIGS. 28 to 31, so that reference is made to the description thereof in this respect.

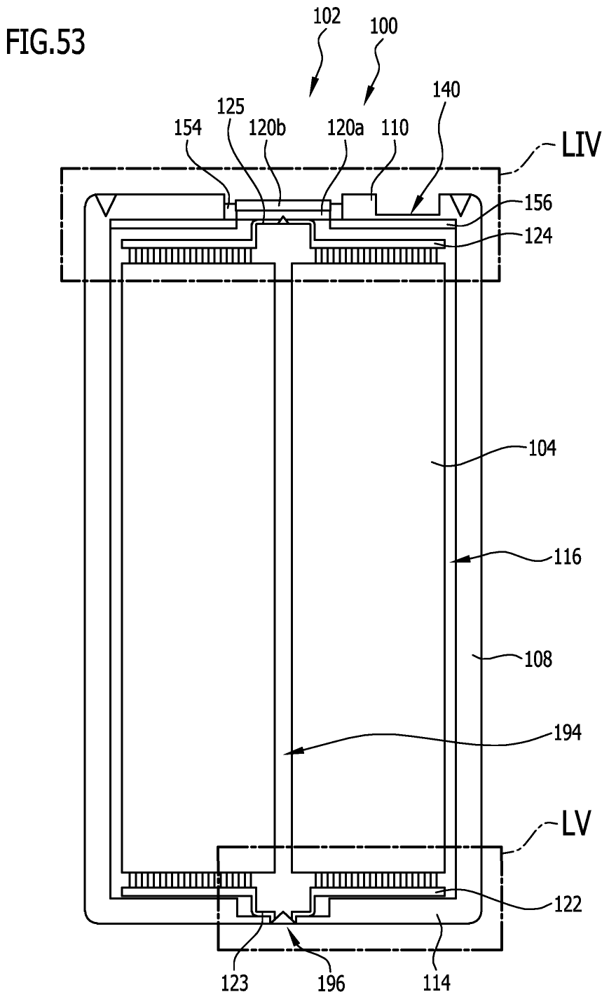

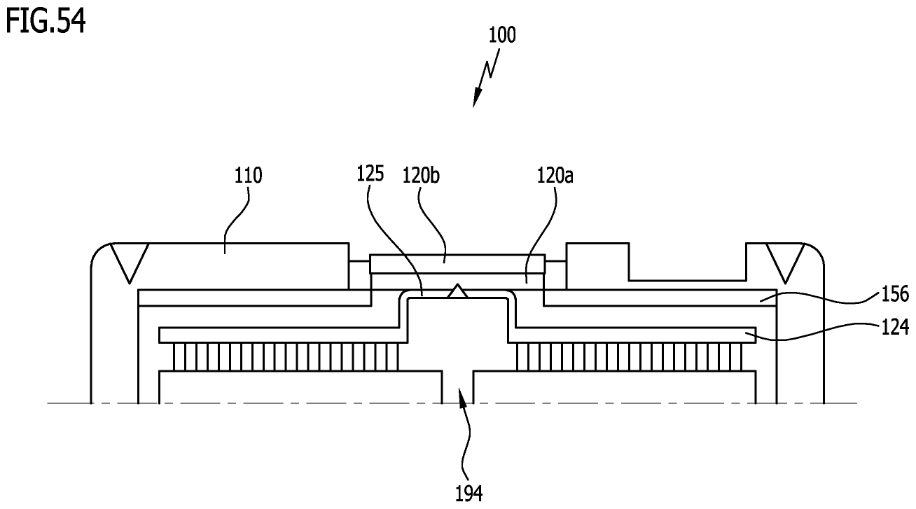

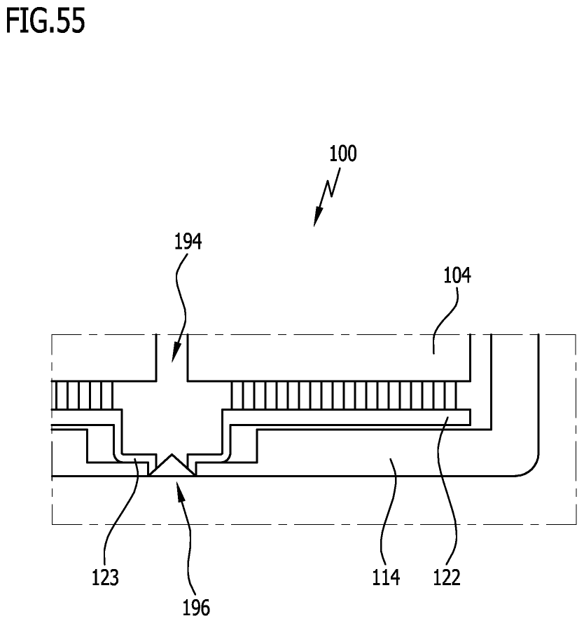

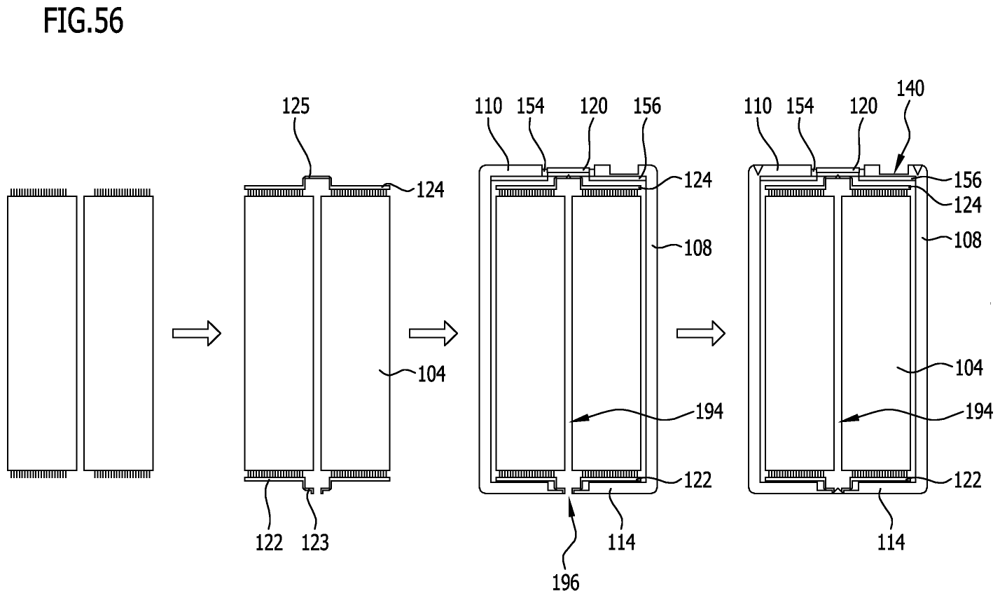

FIGS. 53 to 56 show another embodiment of an electrochemical cell 100 and an embodiment of a method for producing the same.

The embodiment of an electrochemical cell 100 shown in FIGS. 53 to 56 substantially differs in its structure and function from the embodiment shown in FIGS. 49 to 52 in that the cup element 108 has a through-opening 196 in its bottom section 114, which through-opening 196 is and/or will be welded at the end of assembling the electrochemical cell 100.

In particular, the second connecting element 125 and the second cell terminal 120 are welded to one another through the passage opening 196.

It can be beneficial if free ends of the first connecting element 123 are bent away from the electrochemical element 104.

Otherwise, the additional embodiment of an electrochemical cell 100 shown in FIGS. 53 to 56 substantially corresponds in its structure and function to the one in FIGS. 49 to 52, so that reference is made to the description thereof in this respect.

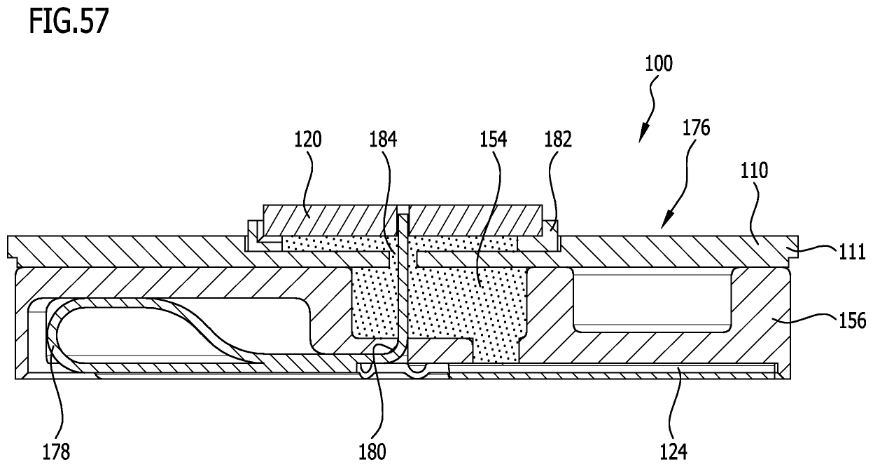

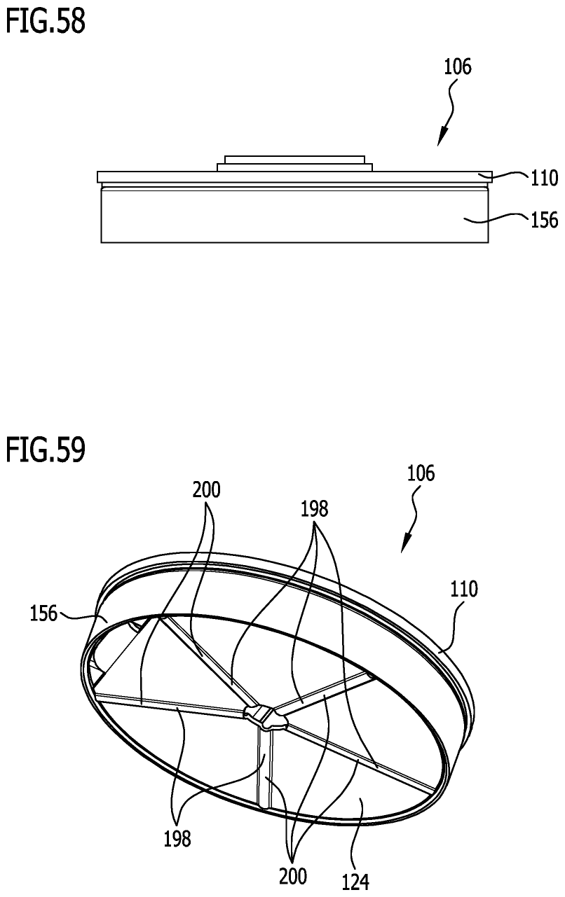

An alternative embodiment of a cover element assembly 176 shown in FIGS. 57 to 59 substantially differs from the embodiment shown in FIGS. 43 to 46 in that the second cell terminal 120 is arranged substantially radially in the middle, and the first bend 178 is designed to be loop-like and/or rounded and/or continuously curved.

The second insulating element 156 preferably accommodates the entire second current collector element 124. For this purpose, the second insulating element 156 is designed, for example, at least approximately cup-shaped and/or disk-shaped.

The cover element assembly 176 can easily be placed or plugged onto a cup element 108, wherein the second insulating element 156 is preferably inserted together with the second current collector element 124 into the open end of the cup element 108, in particular until the open end of the cup element 108 comes to rest against the cover element 110 of the cover element assembly 176, in particular on a cover plate 111, and is connected, for example clamped, welded, etc. thereto.

A side of the second current collector element 124 facing the electrochemical element 104 preferably comprises a plurality of, for example five, elevations 198, which are increased in the direction of the electrochemical element 104. The elevations 198 are in particular beads 200.

The elevations 198 extend in particular in a star shape in the radial direction toward the outside.

The elevations 198 preferably form welding regions for fixed welding on the electrochemical element 104.

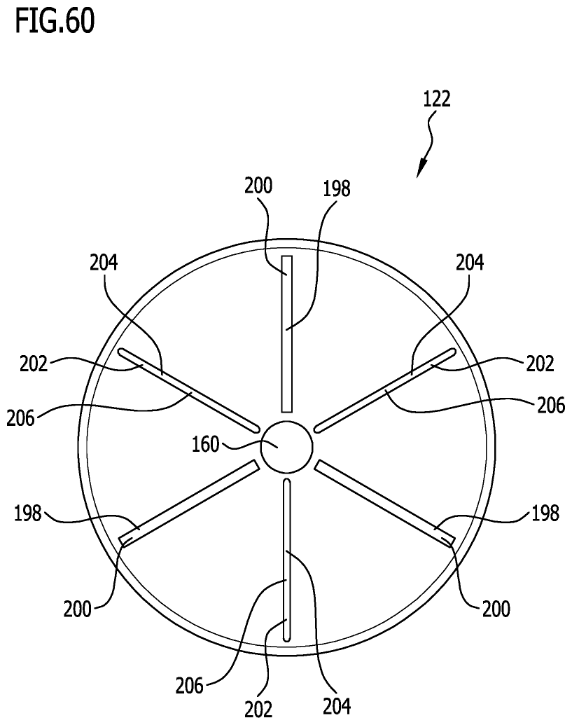

FIG. 60 shows an optimized first current collector element 122, which can be used in these and other embodiments.

A side of the first current collector element 122 facing the electrochemical element 104 preferably comprises a plurality of, for example three, elevations 198, which are increased in the direction of the electrochemical element 104. The elevations 198 are in particular beads 200.

The elevations 198 extend in particular in a star-shaped manner in the radial direction outwards and/or are arranged and/or formed uniformly distributed in the circumferential direction.

The elevations 198 preferably form welding regions for fixed welding on the electrochemical element 104.

Furthermore, the first current collector element 122 preferably comprises one or more openings 202, for example slots 204 or elongated holes 206. The one or more openings 202 extend in particular in the radial direction and/or are arranged and/or formed uniformly distributed in the circumferential direction. In particular, elevations 198 and openings 202 are arranged and/or formed alternately.

In particular, an optimized behavior of the electrochemical cell 100 for degassing and/or during a thermal event can be achieved by the openings 202. In particular, a gas forming between the layers of the electrochemical element 104 can be easily removed through the openings 202.

Otherwise, the additional embodiment of an electrochemical cell 100 shown in FIGS. 57 to 60 substantially corresponds in its structure and function to the embodiment shown in FIGS. 43 to 46, so that reference is made to the description thereof in this respect.

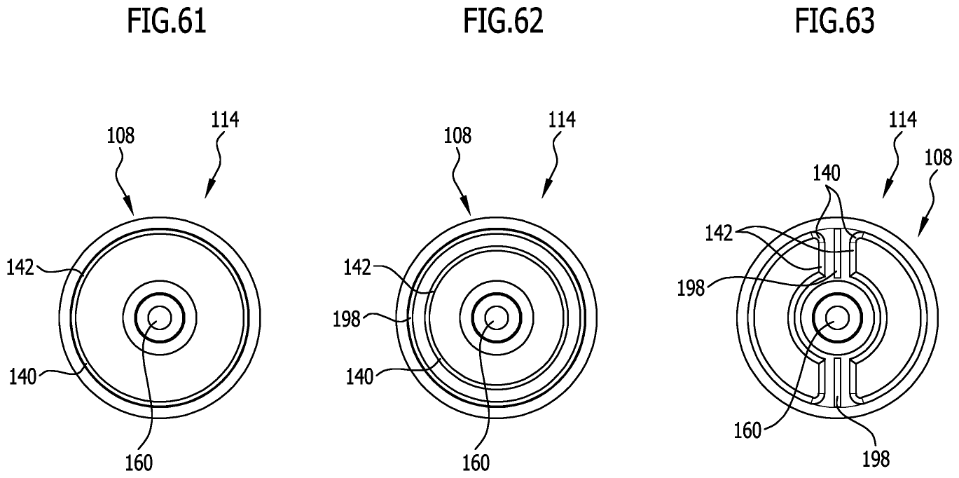

Various variants of a bottom section 114 of the cup element 108 are shown in FIGS. 61 to 63. In this case, a filling opening, in particular an electrolyte filling opening 160, is always provided centrally and is surrounded, for example, by a circumferential embossing and can easily be welded tight by means of a metal plate.

Furthermore, rupture devices 140, in particular rupture webs 142, are provided and/or formed in the bottom sections 114.

Finally, fastening regions for fastening a first current collector element 122 are preferably provided.

According to FIG. 61, it is provided that the first current collector element 122 is clamped to the bottom section 114 or welded circumferentially in an edge region. The rupture web 142 is, for example, circumferentially annular.

According to FIG. 62, an inwardly projecting elevation 198 is provided, which is in particular circular and serves to be welded to the first current collector element 122. A circular annular rupture web 142 is arranged and/or formed in the bottom section 114 in the radial direction within the elevation 198.

According to FIG. 63, two rupture devices 140 are provided, which are each arranged and/or formed substantially in a semicircle around the filling opening. Web-like elevations 198 oriented substantially radially outwards are arranged and/or formed between the two rupture devices 140 and protrude into the interior space 116 and serve to be welded to the first current collector element 122. The elevations 198 are positioned in such a way that the welding does not impair the function of the rupture devices 140.

The described variants of bottom sections 114 or only individual features or combinations of features can optionally be provided in individual, several or all embodiments of the electrochemical cell 100.

The previously described embodiments of electrochemical cells 100 preferably have optimized sealing properties and/or can be easily produced.

1. An electrochemical cell, preferably a cylindrical cell, wherein the electrochemical cell comprises the following:
an electrochemical element for receiving, storing and/or providing electrical energy;
a housing that comprises a cup element for accommodating the electrochemical element and a cover element for covering and/or closing the cup element;
a first cell terminal and a second cell terminal for connecting the electrochemical cell to a cell contacting system; and
a cast element, in particular a first cast element, for connecting the housing and the first cell terminal, and/or
a cast element, in particular a second cast element, for connecting the housing and the second cell terminal.

2. The electrochemical cell according to claim 1, wherein the electrochemical cell comprises a first current collector element, which comprises at least one first connecting element for connecting the first current collector element to the first cell terminal and/or for electrically contacting the electrochemical element and the first cell terminal, wherein the at least one first connecting element is designed in the form of a bulge pointing in the direction of the first cell terminal and/or in the form of a projection pointing in the direction of the first cell terminal, and/or wherein the at least one first connecting element is connected to the first cell terminal in a material-bonded and/or positive and/or force-fitting manner, for example by welding.

3. The electrochemical cell according to claim 1, wherein the electrochemical cell comprises a second current collector element, which comprises at least one second connecting element for connecting the second current collector element to the second cell terminal and/or for electrically contacting the electrochemical element and the second cell terminal, wherein the at least one second connecting element is designed in the form of a bulge pointing in the direction of the second cell terminal and/or in the form of a projection pointing in the direction of the second cell terminal, and/or wherein the at least one second connecting element is connected to the second cell terminal by material bonding and/or form-fitting and/or force-fitting, for example by welding.

4. The electrochemical cell according to claim 2, wherein the at least one first connecting element is formed by bending and/or cutting out, for example punching out, and/or in the at least one second connecting element is formed by bending and/or cutting out, for example punching out.

5. The electrochemical cell according to claim 1, wherein the electrochemical cell has a first insulating element, which forms an electrical isolation and/or an electrical insulation between the first cell terminal and the cup element, and/or the electrochemical cell has a second insulating element, which forms an electrical isolation and/or an electrical insulation between the second cell terminal and the cover element.

6. The electrochemical cell according to claim 1, wherein the first cast element comprises or is formed from a first polymer material, and/or the second cast element comprises or is formed from a second polymer material.

7. The electrochemical cell according to claim 1, wherein the electrochemical cell comprises a first insulating element, which comprises or is formed from a third polymer material, and/or the electrochemical cell comprises a second insulating element, which comprises or is formed from a fourth polymer material, wherein preferably the third polymer material and/or the fourth polymer material comprises or is formed from one or more of the following materials: polyethylene terephthalate, polyethylene, polypropylene, and polybutylene terephthalate.

8. The electrochemical cell according to claim 1, wherein the first cast element is arranged between the first cell terminal and the cup element in radial directions with respect to a central axis of the electrochemical cell, and/or
the second cast element is arranged in radial directions with respect to the central axis of the electrochemical cell between the second cell terminal and the cover element.

9. The electrochemical cell according to claim 1, wherein the cover element and/or the cup element comprises a rupture device, which has a rupture web that is designed in such a way that it breaks and/or tears when a critical pressure is exceeded in an interior space of the electrochemical cell.

10. The electrochemical cell according to claim 9, wherein the rupture web is formed by a linear region of reduced material thickness and/or by two depressions, for example embossings, introduced into the cover element or into the cup element on both sides of the cover element and/or of the cup element.

11. The electrochemical cell according to claim 1, wherein the cover element and/or the cup element has one or more elevations, which project away from a main body of the cover element or the cup element in a direction pointing away from the inner space, wherein the one or more elevations preferably border an opening for accommodating the second cast element.

12. The electrochemical cell according to claim 1, wherein the electrochemical cell, for example the second cell terminal, comprises at least one snap-on element which, when a critical pressure and/or a critical temperature is exceeded in the interior space of the electrochemical cell, can be deflected and/or is deflected from an resting state into a triggered state to the outside and therefore interrupts and/or disconnects an electrical contact between the second cell terminal and a second current collector element, for example.

13. The electrochemical cell according to claim 1, wherein the second cell terminal has a plurality of functional regions, which are separated from one another by the second cast element, wherein the plurality of functional regions are preferably separated from one another by one or more elevations, for example beads, or wherein the plurality of functional regions themselves are designed as elevations and/or plateaus relative to a main body.

14. The electrochemical cell according to claim 1, wherein the electrochemical cell comprises a single cast element by which the second cell terminal or the first cell terminal and the second cell terminal are accommodated and/or surrounded.

15. The electrochemical cell according to claim 1, wherein the electrochemical cell has one or more spacer elements, wherein the one or more of the spacer elements is arranged between the cover element and the first cell terminal, and/or wherein the one or more of the spacer elements is arranged between the cover element and the second cell terminal.

16. The electrochemical cell according to claim 1, wherein a first current collector element of the electrochemical cell is connected to the cup element by a first spring element, for example a spring washer, and/or a second current collector element of the electrochemical cell is connected to the cover element and/or the second cell terminal by a second spring element, for example a spring washer.

17. The electrochemical cell according to claim 1, wherein the electrochemical element is at least approximately hollow-cylindrical and/or has a cavity parallel to the central axis of the electrochemical cell.

18. An electrochemical system comprising one or more electrochemical cells in accordance with claim 1.

19. A method for producing an electrochemical cell, for example for producing an electrochemical cell according to claim 1, wherein the method comprises the following:
providing an electrochemical element for receiving, storing and/or providing electrical energy;
positioning the electrochemical element in a housing, which comprises a cup element for accommodating the electrochemical element and a cover element for covering and/or closing the cup element;
producing a cast element, in particular a first cast element, for connecting the cup element to a first cell terminal, and/or
producing a cast element, in particular a second cast element, for connecting the cover element to a second cell terminal.

20. The method according to claim 19, wherein the electrochemical element is inserted into the cup element and that subsequently, a first current collector element of the electrochemical cell is connected, for example welded, to the first cell terminal.

21. The method according to claim 19, wherein a second insulating element, the cover element and the second cell terminal are stacked before they are cast together with a first resin material and/or a second resin material in a flowable state.

22. The method according to claim 19, wherein the electrochemical element is produced by being wound on and/or around a winding device, for example a winding mandrel, whereby in particular a cavity is formed parallel to the central axis of the electrochemical cell.
